(19) United States
(12) Patent Application Publication
(10) Pub. No.: US 2009/0320141 A1
(43) Pub. Date: Dec. 24, 2009

(54) DOCUMENT DATA SECURITY MANAGEMENT METHOD AND SYSTEM THEREFOR

(75) Inventors: Donglin WANG, Beijing (CN); Xu Guo, Beijing (CN); Changwei Liu, Beijing (CN); Kaihong Zou, Beijing (CN)

Correspondence Address: LADAS & PARRY, 5670 WILSHIRE BOULEVARD, SUITE 2100, LOS ANGELES, CA, 90036-5679, US

(73) Assignee: SURSEN CORP., Beijing (CN)

(21) Appl. No.: 12/133,309

(22) Filed: Jun. 4, 2008

Related U.S. Application Data
(63) Continuation-in-part of application No. PCT/CN2006/003294, filed on Dec. 5, 2006.

(30) Foreign Application Priority Data
Dec. 5, 2005 (CN) 200510126683.6
Dec. 9, 2005 (CN) 200510131071.6

(51) Int. Cl. G06F 21/00; H04L 9/00

(52) U.S. Cl. 726/27; 380/277

(57) ABSTRACT

The present invention discloses a system for document security control to improve the security of document data, and the system comprises: an application, embedded in a machine readable medium, which performs a security control operation on abstract unstructured information by issuing an instruction to a platform software; the platform software, embedded in a machine readable medium, which accepts the instruction from the application and performs the security control operation on storage data corresponding to the abstract unstructured information; wherein, said abstract unstructured information are independent of a way in which said storage data are stored.

### CROSS-REFERENCE TO RELATED APPLICATIONS

This application is a continuation-in-part of International Application No. PCT/CN2006/003294 (filed Dec. 5, 2006), which claims priority to Chinese Application No. 200510126683.6 (filed Dec. 5, 2005) and 200510131071.6 (filed Dec. 9, 2005), the contents of which are incorporated herein by reference. The present application also relates to concurrently-filed U.S. patent application titled “Document Processing System and Method Therefor,” attorney docket no. B-6492CON 624938-5, which claims the priority of International Application No. PCT/CN2006/003293 (filed Dec. 4, 2006); concurrently-filed U.S. patent application titled “Document Processing System and Method Therefor,” attorney docket no. B-6493CON 624939-3, which claims the priority of International Application No. PCT/CN2006/003297 (filed Dec. 5, 2006); concurrently-filed U.S. patent application titled “A Method of Hierarchical Processing of a Document and System Therefor,” attorney docket no. B-6494CON 624940-8, which claims the priority of International Application No. PCT/CN2006/003295 (filed Dec. 5, 2006); and concurrently-filed U.S. patent application titled “Document Processing Method,” attorney docket no. B-6491CIP 624937-7, which claims the priority of International Application No. PCT/CN2006/003296 (filed Dec. 5, 2006), the entire contents of which are incorporated herein by reference.

### FIELD OF THE INVENTION

The present invention relates to a document data processing technique, and particularly, to a method and system for document data security management and a docbase management system.

### BACKGROUND OF THE INVENTION

Information in the existing systems can be divided into structured data and unstructured data. The structure of structured data, i.e., a 2-dimentional table structure, is comparatively simple, and the processing technique of structured data is typically used for processing data by mainly employing database systems. However, unstructured data mainly including text documents and streaming media does not have fixed data structure, which makes unstructured data processing very complicated.

Varieties of unstructured document processing software are popular among users and different document formats are used at present, e.g., existing document editing applications include Microsoft Word, WPS, Yongzhong Office, Red Office, etc. Usually a contents management application has to handle two to three hundred ever updating document formats, which brings great difficulty to software developers. The document universality, digital contents extraction and format compatibility are becoming the focus of the industry, and problems as follows need solutions.

1) Documents are non-universal.

Users only can exchange documents processed with a same application, but cannot exchange documents processed with different applications, which causes information blockage.

2) Access interfaces are non-unified and data compatibility costs highly.

Since the document formats provided by different document processing applications are not compatible with each other, a component of another application should be used for a document processing application to parse an incompatible document (if that another application provides a corresponding interface) or a lot of research resources are spent in the software development stage to parse the document format from head to heel.

3) Information security is poor.

The privilege control measures for text documents are quite monotonous, mainly including data encryption and password authentication, and massive damages caused by information leak in companies are found every year.

4) Processes are only for single document and multi-document management is lack.

A person may have a large number of documents in his computer, but no efficient organization and management measure is provided for multiple document and it is difficult to share resources such as font/typeface file, full text data search, etc.

5) Techniques for layering pages are insufficient.

Some applications, e.g., Adobe Photoshop and Microsoft Word, have more or less introduced the concept of layer, yet the layer functions and layer management are too simple to meet the practical demands.

6) Search methods are monotonous.

Massive information in the present networks results in a huge number of search results for any search keyword, and precision ratio has become the major concern while full text search technique has solved the problem of recall ratio. However, the prior art does not fully utilize all information to improve the precision ratio. For example, the font or size of characters, may be used for determining the importance of the characters, but are ignored by the present search techniques.

Large companies are all working to make their own document formats the standard formats in the market and standardization organizations are also bending to the creation of universal document format standards. Nevertheless, a document format, no matter a proprietary document format (e.g., .doc format) or an open document format (e.g., .PDF format), leads to problems as follows.

a) Repeated Development and Inconsistent Performance

Different applications which adopt a same document format standard have to find their own ways to render and generate documents in compliance with the document format standard, which results in repeated research and development. Furthermore, the rendering components developed by some applications provide excellent performance while others provide only basic functions, some software applications support a new version of the document format standard while others only support an old version, hence different applications may present a same document in different page layouts, rendering error may even occur with some applications which are consequentially unable to open the document.

b) Barrier to Innovation

Software industry is an industry with ever-developing innovation, however, when a new function is added, description information of the function needs adding into corresponding standard, and a new format can only be brought forward when the standard is revised. Hence a fixed storage format holds back the technical innovation competition.

c) Impaired Search Performance

Search performance is enhanced for massive information by adding more search information, yet it is hard for a fixed storage format to allow more search information.

d) Impaired Transplantability and Scalability

Different applications in different system environments have different storage needs. For example, an application needs to reduce seek times of disk head to improve performance when the data saved in a hard disk, while an embedded application does not need to do that because the data of the embedded application are saved in system memory. And for example e.g., database software applications provided by a same manufacturer may use different storage formats on different platforms. Hence the document storage standards affect transplantablity and scalability of the system.

In prior art, the document format that provides best performance concerning openness and interchangeability is the PDF format from Adobe Acrobat. However, even though the PDF format has actually become a standard for document distribution and exchange around the globe, different applications cannot exchange PDF documents, i.e., PDF documents provides no interoperability. What's more, both Adobe Acrobat and Microsoft Office can process only one document at a time and can neither manage multiple documents nor operate with docbases.

In addition, the existing techniques are significantly flawed concerning document information security. Documents currently used in the widest range, e.g., Word documents and PDF documents, adopt data encryption or password authentication for data security control without any systematic identity authentication mechanism. The privilege control cannot be applied to segments within a document but only to the whole document. The encryption and signature of logic data are limited, i.e., encryption and signature cannot be applied to arbitrary logic data. On the other hand, a contents management system, while providing satisfactory identity authentication mechanism, is separated with a document processing system and cannot be integrated on the core layer. Therefore the contents management system can only provide management down to the document level, and the document will be out of the security control of the contents management system when the document is in use. Hence essential security control cannot be achieved in this way. And the security and document processing are usually handled by separated modules, which may easily cause security breaches.

Some of existing security management techniques and concepts are introduced herein.

Current security management techniques usually adopt an asymmetric key encryption algorithm, also known as Public Key Infrastructure (PKI) algorithm. A key generated by the algorithm for an encryption is different from the key for corresponding decryption. The key for encryption and the key for decryption do not lead to each other in deduction, i.e., when a user make one of the keys public, the other key can still remain private. Therefore others may encrypt a piece of information to be transmitted with the public key and transmit the information safely to the user, and the user decrypts the information with the private key. The PKI technique solves the problem of publishing and managing security keys and is the most common cryptograph technique at present. By using the PKI technique, two parties of a data transmission can safely authenticate the identity of each other and publish a security key, i.e., the transmission can be authenticated. Common PKI algorithms at present include Elliptic Curves Cryptography (ECC) algorithm, Ron Rivest, Adi Shamir, Len Adleman (RSA) encryption algorithm, etc. The RSA encryption algorithm and ECC algorithm are explained in summary hereinafter.

1. RSA Algorithm

Public key: n=pq, (p, q are two very large different prime numbers, and p and q must be kept secret);

φ(n)=(p−1)×(q−1);

choose an integer e(1<e<φ(n)) which is relatively prime to φ(n);

Private key: d=e−1 mod φ(n), i.e., find a number d which satisfy the equation d=e−1 mod φ(n);

Encrypt: c=mc(mod n);

Decrypt: m=cd(mod n), wherein m is clear text and c is cryptographed text.

2. ECC Algorithm

The ECC algorithm is another asymmetric key encryption algorithm which adopts Elliptic Curves in the encryption. The ECC algorithm has been studied in cryptanalysis even since the ECC algorithm came out, and an ECC system is considered to be safe in commercial and government applications. According to the present cryptanalysis, the ECC system provides better security than conventional cryptograph systems.

The ECC algorithm is explained as follows.

A normal curve equation can be transformed by an elliptic curve in the large prime field, through isomorphic mapping, into a simple equation: y²=x³+ax+b, wherein curve parameters a, bεFp and 4a³+27b²≈0(mod p).

Hence all points (x,y) serving as the solution to the following equation, plus a point at infinity O∝, form an elliptic curve in the large prime field Fp:

Y²=x³+ax+b(mod p).

In this equation x and y are large prime numbers in the field between 0 and p−1, and the elliptic curve is expressed as Ep(a,b).

In the equation:

K=kG,

wherein K and G are points on the Ep(a,b) and k is an integer smaller than n, and n is the order of point G, it is obvious that, according to the rule for adding, when the k and G are given, it will be easy to obtain K through calculation, however, when K and G are given, it will be very difficult to obtain k.

This is the mathematical theory on which the ECC system is based. Point G is called a base point, k (k<n and n is the order of point G) is the private key and K is the public key.

The encryption algorithm can also include a commonly known symmetric algorithm, which provides a same key for both encryption and decryption. For example, Advanced Encryption Standard (AES) algorithm is a code algorithm developed to protect government information. Rijndael algorithm was selected from 15 candidate algorithms as the AES algorithm. The AES algorithm provides symmetric iterated block cipher. The algorithm divides data blocks into bit arrays and every cipher operation is bit oriented. The Rijndael algorithm includes four layers, the first layer includes 8×8 bit permutation (i.e., 8 bits of input and 8 bits of output), the second and third layers include linear mixing layers (shiftrows and mixcolumns in arrays) and the fourth layer includes bitwise EXOR of expanded keys and arrays.

AES fixes the block length to 128 bits, and supports key lengths of 128, 192 or 256 bits, the numbers of round r corresponding to different key lengths are 10/12/14 respectively, and corresponding encryption schemes can be summarized as: r+1 expanded keys are needed in the encryption, and 4(r+1) 32-byte words shall be constructed. When the seed bits are 128 or 192 bits, the 4(r+1) 32-byte words are constructed in a same way; when the seed bits are 256 bits, the 4(r+1) 32-byte words shall be constructed in a different way.

Furthermore, HASH, also known as hashing, message digest or digital digest, is another concept commonly used for security information management. A one-way hash function takes a data of any length as input and produces a fixed length irreversible string, i.e., the HASH value of the data. Theoretically, all HASH algorithms inevitably have collision (a situation that occurs when two distinct inputs into a hash function produce identical outputs). A HASH algorithm is secure in two senses. Firstly, a HASH value cannot be used for reversed computation to retrieve the original data. Secondly, in practical calculation it is impossibility to construct two distinct data which have the identical HASH values, though the possibility is acknowledged in theory. MD5, SHA1 and SHA256 are considered as HASH algorithms relatively secure at present. In addition, the computation of HASH function is comparatively fast and simple.

### SUMMARY OF THE INVENTION

The present invention provides a method and system for document security control to eliminate the security flaws in the document processing techniques described in the foregoing introduction.

The present invention provides a powerful embedded information security function which applies information security technology in the core layer to offer maximum security to documents.

A system for document security control provided comprises:

an application, embedded in a machine readable medium, which performs a security control operation on abstract unstructured information by issuing an instruction to a platform software;

the platform software, embedded in a machine readable medium, which accepts the instruction from the application and performs the security control operation on storage data corresponding to the abstract unstructured information;

wherein, said abstract unstructured information are independent of a way in which said storage data are stored.

A machine readable medium having instructions stored thereon that when executed cause a system to:

perform a security control operation on abstract unstructured information by issuing an instruction to a platform software; wherein, said abstract unstructured information are independent of the way in which corresponding storage data are stored.

A machine readable medium having instructions stored thereon that when executed cause a system to:

accept an instruction from an application which perform a security control operation on abstract unstructured information by issuing the instruction;

perform the security control operation on storage data corresponding to the abstract unstructured information; wherein, said abstract unstructured information are independent of the way in which the storage data are stored.

A computer-implemented system, comprising:

means for performing a security control operation on abstract unstructured information by issuing an instruction;

means for accepting the instruction from the application and performs the security control operation on storage data corresponding to the abstract unstructured information;

wherein, said abstract unstructured information are independent of a way in which said storage data are stored.

A system for document security control provided comprises:

an application, embedded in a machine readable medium, which performs a security control operation on abstract unstructured information by issuing an instruction to a platform software;

the platform software, embedded in a machine readable medium, which accepts the instruction from the application and performs the security control operation on storage data corresponding to the abstract unstructured information;

wherein, said abstract unstructured information are independent of a way in which said storage data are stored.

According to the present invention, a document processing technique based on separating the application layer and the data processing layer can integrate information security into the core layer of document processing. Therefore security breaches will be eliminated, and the security mechanism and document processing mechanism will be combined into one module instead of two module. More space is thus provided for security management and corresponding codes can thus be hidden deeper and used more effectively for defending illegal attack and improving security and reliability. In addition, fine-grained security management measures can be taken, e.g., more privilege classes and smaller management divisions can be adopted. The invention also provides a universal document security model which satisfies the demands of various applications concerning document security so that different applications can control document security via a same interface.

### BRIEF DESCRIPTION OF THE DRAWINGS

FIG. 1 is a block diagram of the structure of a document processing system.

FIG. 2 shows the organization structure of the universal document model in Preferred Embodiment of the present invention.

FIG. 3 shows the organization structure of the docbase object in the universal document model shown in FIG. 2.

FIG. 4 shows the organization structure of the docbase helper object in the docbase object shown in FIG. 3.

FIG. 5 shows the organization structure of the docset object in the docbase object shown in FIG. 3.

FIG. 6 shows the organization structure of the document object in the docset object shown in FIG. 5.

FIG. 7 shows the organization structure of the page object in the document object shown in FIG. 6.

FIG. 8 shows the organization structure of the layer object in the page object shown in FIG. 7.

FIG. 9 shows the organization structure of the layout object in the layer object shown in FIG. 8.

FIG. 10 shows a document processing system with UOML interface.

FIG. 11 is a flow chart of the method for document data security management provided by the present invention.

### DETAILED DESCRIPTION OF THE INVENTION

The present invention is further described hereinafter in detail with reference to accompanying drawings and embodiments. It should be understood that the embodiments offered herein are used for explaining the present invention only and shall not be used for limiting the protection scope of the present invention.

The method and system for security management of the present invention are mainly applied to document processing systems described hereafter.

Problems existing among prior document processing applications include: poor universality, difficulties in extracting document information, inconsistent access interfaces, difficulties or high cost on achieving data compatibility, impaired transplantability and scalability, underdeveloped page layered technique and too monotonous search method. In the prior art, one single application implements functions of both user interface and document storage, the present invention solves the problems by dividing a document processing application into an application layer and a docbase management system layer. The present invention further sets up an interface standard for interaction between the two layers and may even further create an interface layer in compliance with the interface standard. The docbase management system is a universal technical platform with all kinds of document processing functions and an application issues an instruction to the docbase management system via the interface layer to process a document, then the docbase management system performs corresponding operation according to the instruction. In this way, as long as different applications and docbase management systems follow the same standard, different applications can process a same document through a same docbase management system, therefore document interoperability is achieved. Similarly, one application may process different documents through different docbase management systems without independent development on every document format.

Furthermore, the technical scheme of the present invention provides a universal document model which makes different applications compatible with different documents to be processed. The interface standard is based on the document model so that different applications can process a same document via the interface layer. The universal document model can be applied to all types of document formats so that one application may process documents in different formats via the interface layer. The interface standard defines various instructions based on the universal document model for operations on corresponding documents and the way of issuing instructions by an application to a docbase management system(s). The docbase management system has functions to implement the instructions from the application. The universal model includes multiple hierarchies such as a docset including a number of documents, a docbase and a document warehouse. And the interface standard includes instructions covering organization management, query and security control, of multiple documents. In the universal model, a page is separated into multiple layers from bottom to top and the interface standard includes instructions for operations on the layers, storage and extraction of a source file corresponding to a layer in a document. In addition, the docbase management system has information security management control functions for documents, e.g., role-based fine-grained privilege management, and corresponding operation instructions are defined in the interface standard.

According to the present invention, the application layer and the data processing layer are separated with each other. An application no longer needs to deal with document formats directly and a document format is no longer associated with a specific application. Therefore a document can be processed by different applications and an application can process documents in different formats and document interoperability is achieved. The whole document processing system can further process multiple documents instead of one document. When a page in a document is divided into multiple layers, different management and control policies can be applied to different layers to facilitate operations of different applications on the same page (it can be designed that different applications manage and maintain different layers) and further facilitate source file editing and it is also a good way to preserve the history of editing.

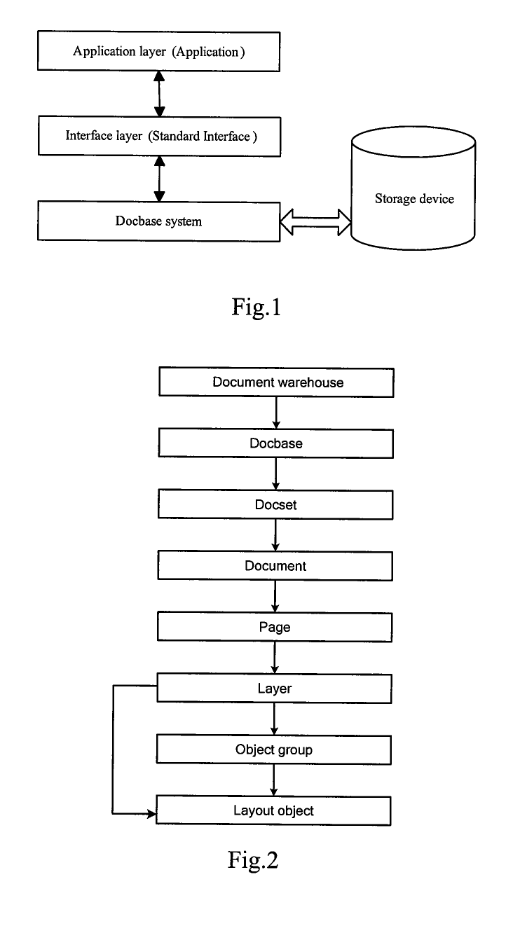

The document processing system in which the method and system for security management of the present invention are applied is explained in detail with reference to figures from FIG. 1 to FIG. 10.

As shown in FIG. 1, the document processing system in accordance with the present invention includes an application, an interface layer, a docbase management system and a storage device.

The application includes any of existing document processing and contents management applications in the application layer of the document processing system, and the application sends an instruction in compliance with the interface standard to process documents. All operations are applied on documents in compliance with the universal document model regardless of the storage formats of the documents.

The interface layer is in compliance with the interface standard for interaction between the application layer and the docbase management system. The application layer sends standard an instruction to the docbase management system via the interface layer and the docbase management system returns the result of corresponding operation to the application layer via the interface layer. It can be seen that, since all applications can sends a standard instruction via the interface layer to process a document in compliance with the universal document model, different applications can process a same document through a same docbase management system and a same application can process documents in different formats through different docbase management systems.

Preferably, the interface layer includes an upper interface unit and a lower interface unit. The application layer can send a standard instruction from the upper interface unit to the lower interface unit and the docbase management system receives the standard instruction from the lower interface unit. The lower interface unit is further used for returning the result of the operation performed by the docbase management system to the application system through the upper interface unit. In practical applications, the upper interface unit can be set up in the application layer and the lower interface unit can be set up in the docbase management system.

The docbase management system is the core layer of the document processing system and performs an operation on a document according to a standard instruction from the application through the interface layer.

The storage device is the storage layer of the document processing system. A common storage device includes a hard disk or memory, and also can include an optical disk, flash memory, floppy disk, tape, remote storage device, or any kind of device that is capable of storing data. The storage device stores multiple documents and the way of storing the documents is irrelevant to applications.

It can thus be seen that the present invention enables the application layer to be separated from the data processing layer in deed. Documents are no longer associated with any specified applications and an application no longer needs to deal with document formats. Therefore different applications can edit a same document in compliance with the universal document model and satisfactory document interoperability is achieved among the applications.

The system for processing the document may comprise an application and a platform software (such as docbase management system). The application performs an operation on abstract unstructured information by issuing one or more instructions to the platform software. The platform software receives the instructions, maps the operation on abstract unstructured information to the operation on storage data corresponding to the abstract unstructured information, and performs the operation on the storage data. It is noted that the abstract unstructured information are independent of the way in which the storage data are stored.

Storage data refer to various kinds of information maintained or stored on a storage device (e.g., a non-volatile persistent memory such as a hard disk drive, or a volatile memory) for long-term usage and such data can be processed by a computing device. The storage data may include complete or integrated information such as an office document, an image, or an audio/video program, etc. The storage data are typically contained in one disk file, but such data may also be contained in multiple (related) files or in multiple fields of a database, or an area of an independent disk partition that is managed directly by the platform software instead of the file system of the OS. Alternatively, storage data may also be distributed to different devices at different places. Consequently, formats of the storage data may include various ways in which the information can be stored as physical data as described above, not just formats of the one or more disk files.

Storage data of a document can be referred to as document data and it may also contain other information such as security control information or editing information in addition to the information of visual appearance of the document. A document file is the document data stored as a disk file.

Here, the word “document” refers to information that can be printed on paper (e.g., static two-dimension information). It may also refer to any information that can be presented, including multi-dimension information or stream information such as audio and video.

In some embodiments, an application performs an operation on an (abstract) document, and it needs not to consider the way in which the data of the document are stored. A platform software (such as a docbase management system) maintains the corresponding relationship between the abstract document and the storage data (such as a document file with specific format), e.g., the platform software maps an operation performed by the application on the abstract document to an operation actually on the storage data, performs the operation on the storage data, and returns the result of such operation back to the application when the return of the result is requested.

In some embodiments, the abstract document can be extracted from the storage data, and different storage data may correspond to the same abstract document. For example, when the abstract document is extracted from visual appearance (also called layout) of the document, different storage data having the same visual appearance, no matter the ways in which they are stored, may correspond to the same abstract document. For another example, when a Word file is converted to a PDF file that has same visual appearance, the Word file and the PDF file are different storage data but they correspond to the same abstract document. Even when the same document is stored in different versions of Word formats, these versions of Word files are different storage data but they correspond to the same abstract document.

In some embodiments, in order to record the visual appearance properly, it would be better to record position information of visual contents, such as text, image and graphic, together with resources referenced, such as linked pictures and nonstandard fonts, to ensure fixed position of the visual contents and to guarantee that the visual contents is always available. A layout-based document meets the above requirements and is often used as storage data of the platform software.

The storage data created by platform software is called universal data since it is accessible by standard instructions and can be used by other applications that conform to the interface standard. Besides universal data, an application is also able to define its own unique data format such as office document format. After opening and parsing a document with its own format, the application may request creating a corresponding abstract document by issuing one or more standard instructions, and the platform software creates the corresponding storage data according to the instructions. Although the format of the newly created storage data may be different from the original data, the newly created storage data, the universal data, corresponds to the same abstract document with the original data, e.g., it resembles the visual appearance of the original data. Consequently, as long as any document data (regardless of its format) corresponds to an abstract document, and the platform software is able to create a storage data corresponding to the abstract document, any document data can be converted to an universal data that corresponds to same abstract document and is suitable to be used by other applications, thus achieving document interoperability between different applications conforms to the same interface standard.

For a non-limiting example, an interoperability process involving two applications and one platform software is described below. The first application creates first abstract document by issuing a first set of instructions to the platform software, and the platform software receives the first set of instructions from the first application and creates a storage data corresponding to the first abstract document. The second application issues a second set of instructions to the platform software to open the created storage data, and the platform software opens and parses the storage data according to the second set of instructions, generating second abstract document corresponding to the said storage data. Here, the second abstract document is identical to or closely resembles the first abstract document and the first and second sets of instructions conform to the same interface standard, making it possible for the second application to open the document created by first application.

For another non-limiting example, another interoperability process involving one application and two platform software is described below. The first platform software parses first storage data in first data format, generates a first abstract document corresponding to the storage data. The application retrieves all information from the first abstract document by issuing a first set of instructions to the first platform software. The application creates a second abstract document which is identical to or closely resembles the first abstract document by issuing a second set of instructions to the second platform software. The second platform creates second storage data in second data format according the second set of instructions. Here, the first and second sets of instructions conform to the same interface standard, enabling the application to convert data between different formats and retain the abstract feature unchanged. The interoperability process involving multiple applications and multiple platform software can be deduced from the two examples above.

Due to limiting factors such as document formats and functions of relative software, the storage data may not be mapped to the abstract document with 100% accuracy and there may be some deviations. For a non-limiting example, such deviations may exist regardless of the precision floating point numbers or integers used to store coordinates of the visual contents. In addition, there may be deviations between the displaying/printing color and the predefined color if the software used for displaying/printing lacks necessary color management functions. If these deviations are not significant (for non-limiting examples, a character's position deviated 0.01 mm from where it should be, or an image with lossy compression by JPEG), these deviations can be ignored by users. The degree of deviation accepted by the users is related to practical requirements and other factors, for example, a professional art designer would be stricter with the color deviation than most people. Therefore, the abstract document may not be absolutely consistent with the corresponding storage data and displaying/printing results of different storage data corresponding to the same abstracted visual appearance may not be absolutely same with each other. Even if same applications are used to deal with the same storage data, the presentations may not be absolutely the same. For example, the displaying results under different screen resolutions may be slightly different. In the present invention, “similar” or “consistent with” or “closely resemble” is used to indicate that the deviation is acceptable, (e.g., identical beyond a predefined threshold or different within a predefined threshold). Therefore, storage data may correspond to, or be consistent with, a plurality of similar abstract documents.

The corresponding relationship between the abstract document and the storage data can be established by the platform software in many different ways. For example, the corresponding relationship can be established when opening a document file, the platform software parses the storage data in the document file and forms an abstract document to be operated by the application. Alternatively, the corresponding relationship can be established when platform software receives an instruction indicating creating an abstract document from an application, the platform software creates the corresponding storage data. In some embodiments, the application is aware of the storage data corresponding to the abstract document being processed (e.g., the application may inform the platform software where the storage data are, or the application may read the storage data into memory and submit the memory data block to the platform software). In some other embodiments, the application may “ignore” the storage data corresponding to the operated abstract document. For a non-limiting example, the application may require the platform software to search on Internet under certain condition and open the first searched documents.

Generally speaking, the abstract document itself is not stored on any storage device. Information used for recording and describing the abstract document can be included in the corresponding storage data or the instruction(s), but not the abstract document itself. Consequently, the abstract document can be called alternatively as a virtual document.

In some embodiments, the abstract document may have a structure described by a document model, such as a universal document model described hereinafter. Here, the statement “document data conform to the universal document model” means that the abstract document extracted from the document data conforms to the universal document model. Since the universal document model is extracted based on features of paper, any document which can be printed on a paper conforms to the document model, making such document model “universal”.

In some embodiments, other information such as security control, document organization (such as the information about which docset a document belongs to), invisible information like metadata, interactive information like navigation and thread, can also be extracted from the document data in addition to visual appearance of the document. Even multi-dimension information or stream information such as audio and video can be extracted. All those extracted information can be referred to jointly as abstract information. Since there is no persistent storage for the abstract information, the abstract information also can be referred to as virtual information. Although most of embodiments of the present invention are based on the visual appearance of the document, the method described above can also be adapted to other abstract information, such as security control, document organization, multi-dimension or stream information.

There are various ways to issue the instruction used for operating on the abstract information, such as issuing a command string or invoking a function. An operation on the abstract information can be denoted by instructions in different forms. The reason why invoking a function is regarded as issuing the instruction is that addresses of difference functions can be regarded as different instructions respectively, and parameter(s) of the function can be regarded as parameter(s) of the instruction. When the instruction is described under “an operation action+an object to be operated” standard, the object in the instruction may either be the same or different from an object of the universal document model. For example, when setting the position of a text object of a document, the object in the instruction may be the text object, which is the same as the object of the universal document model, or it may be a position object of the text which is different with the object of the universal document model. In actual practice, it will be convenient to unify the objects of the instructions and the objects of universal document model.

The method described above is advantageous for document processing as it separates the application from the platform software. In practice, the abstract information and the storage data may not be distinguished strictly, and the application may even operate on the document data directly by issuing instruction to the platform software. Under such a scenario, the instruction should be independent of formats of the document data in order to maintain universality. More specifically, the instruction may conform to an interface standard independent of the formats of the document data, and the instruction may be sent through an interface layer which conforms to the interface standard. However, the interface layer may not be an independent layer and may comprise an upper interface unit and a lower interface unit, where the upper interface unit is a part of application and the lower interface unit is a part of platform software.

The embodiments of the document processing system provided by the present invention are described hereinafter.

Universal Document Model

The universal document model can be defined with reference to the features of paper since paper has been the standard means of recording document information, and the functions of paper are just enough to satisfy the needs of practical applications in work and living.

If a page in a document is regarded as a piece of paper, all information put down on the paper should be recorded, so the universal document model which is able to describe all visible contents on the page is demanded. The page description language (e.g., PostScript) in the prior art is used for describing all information to be printed on the paper and will not be explained herein. However, the visible contents on the page can always be categorized into three classes: characters, graphics and images.

When the document uses a specific typeface or character, corresponding font shall be embedded into the documents to guarantee identical output on screens/printer of different computers. The font resources shall be shared to improve storage efficiency, i.e., only one font needs to be embedded when a same character is used for different places. An image sometimes may be used in different places, e.g., the image may be used as the background images of all pages or as a frequently appearing company logo and it will be better to share the image, too.

Obviously, as a more advanced information process tool, the universal document model not only imitates paper, but also develops some enhanced digital features, such as metadata, navigation, thread, minipage, etc. Metadata includes data used for describing data, e.g., the metadata of a book includes information of author, publishing house, publishing date and ISBN. Metadata is a common term in the industry and will not be explained further herein. Navigation includes information similar to the table of contents of a book, and navigation is also a common term in the industry. The thread information describes the location of a passage and the order of reading, so that when a reader finishes a screen, the reader can learn what information should be displayed on the next screen. The thread also enables automatic column shift and automatic page shift without manually appointing a position by the reader. Minipage includes miniatures of all pages and the miniatures are generated in advance, the reader may choose a page to read by checking the miniatures.

FIG. 2 shows a universal document model in a preferred embodiment of the present invention. As shown in FIG. 2, the universal document model includes multiple layers including a document warehouse, docbase, docset, document, page, layer, object group and layout object.

The document warehouse consists of one or multiple docbases, and the relation among docbases is not as strictly regulated as the relation among hierarchies within a docbase. Docbases can be combined and separated simply without modifying the data of the docbases, and usually no unified index is set up for the docbases (especially a fulltext index), so most of operations on document warehouse search traverse the indexes of all the docbases without an available unified index. Every docbase consists of one or multiple docsets and every docset consists of one or multiple documents and possibly a random number of sub docsets. A document includes a normal document file (e.g., a .doc document) in the prior art and the universal document model may define that a document may belong to one docset only or belong to multiple docsets. A docbase is not a simple combination of multiple documents but a tight organization of the documents, especially the great convenience can be brought after unified query indexes are established for the document contents.

Every document consists of one or multiple pages in an order (e.g., from the front to the back), and the cores of the pages may be different. A page core may be even not in a rectangle shape but in a random shape expressed by one or multiple closed curves.

Further a page consists of one or multiple layers in an order (e.g., from the top to the bottom), and one layer is overlaid with another layer like one piece of glass over another piece of glass. A layer consists of a random number of layout objects and object groups. The layout objects include statuses (typeface, character size, color, ROP, etc.), characters (including symbols), graphics (line, curve, closed area filled with specified color, gradient color, etc.), images (TIF, JPEG, BMP, JBIG, etc.), semantic information (title start, title end, new line, etc.), source file, script, plug-in, embedded object, bookmark, streaming media, binary data stream, etc. One or multiple layout objects can form an object group, and an object group can include a random number of sub object groups.

The docbase, docset, document, page and layer may further include metadata (e.g., name, time of latest modification, etc., the type of the metadata can be set according to practical needs) and/or history. The document may further include navigation information, thread information and minipage. And the minipage may be placed in the page or the layer. The docbase, docset, document, page, layer and object group may also include digital signatures. The semantic information had better follow layout information to avoid data redundancy and facilitates the establishment of the relation between the semantic information and the layout. The docbase and document may include shared resources such as a font and image.

Further the universal document model may define one or multiple roles and grant certain privileges to the roles. The privileges are granted based on units including a docbase, docset, document, page, layer, object group and metadata. Privileges define whether a role is authorized to read, write, copy or print any one or any combination of the above units.

The universal document model is beyond the conventional way of one document for one file. A docbase includes multiple docsets and a docset includes multiple documents. Fine-grained access and security control is applied to document contents in the docbase so that even an individual character or rectangle can be accessed in the docbase while the prior document management system can only access as far as file name.

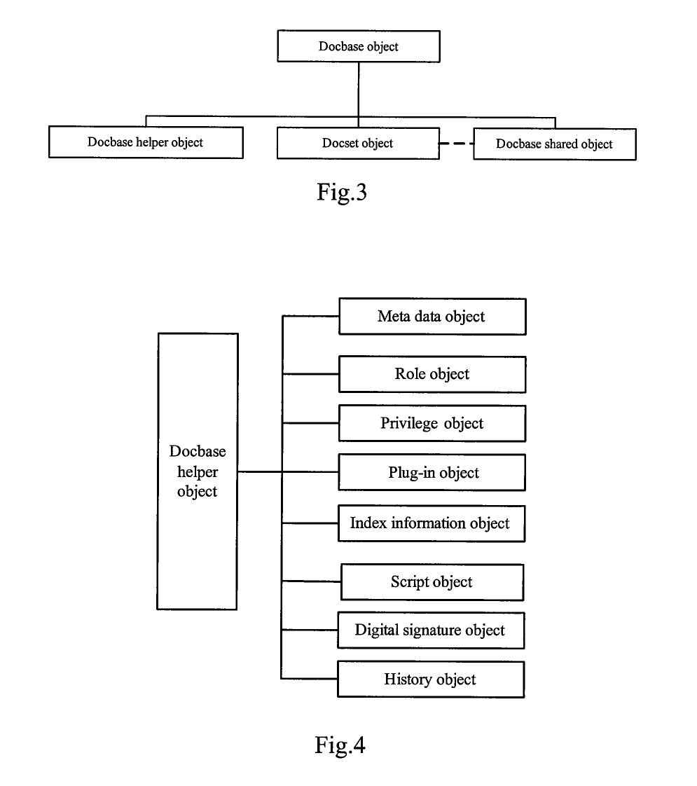

Figures from FIG. 3 to FIG. 9 are schematics illustrating the organization structures of various objects in the universal document model of Preferred Embodiment 1 of the present invention. The organization structures of the objects are tree structures and are developed layer by layer into smaller objects.

The document warehouse object consists of one or multiple docbase objects (not shown in the drawings).

As shown in FIG. 3, the docbase object includes one or multiple docset objects, a random number of docbase helper objects and a random number of docbase shared objects.

As shown in FIG. 4, the docbase helper object includes: a metadata object, role object, privilege object, plug-in object, index information object, script object, digital signature object and history object etc. The docbase shared object includes an object that may be shared among different documents in the docbase, such as a font object and an image object.

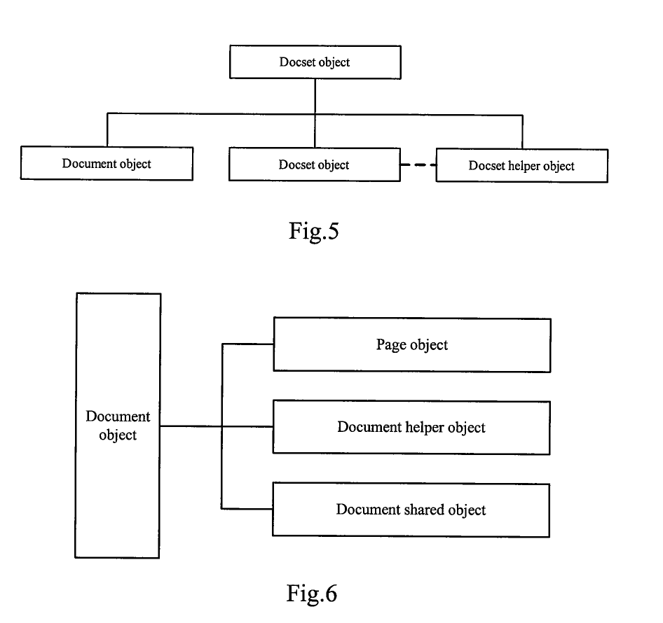

As shown in FIG. 5, every docset object includes one or multiple document objects, a random number of docset objects and a random number of docset helper objects. The docset helper object includes a metadata object, digital signature object and history object. When the docset object includes multiple docset objects, the structure of the object is similar to the structure of a folder including multiple folders in the Windows system.

As shown in FIG. 6, every document object includes one or multiple page objects, a random number of document helper objects and a random number of document shared objects. The document helper object includes a metadata object, font object, navigation object, thread object, minipage object, digital signature object and history object. The document shared object includes an object that may be shared by different pages in the document, such as an image object and a seal object.

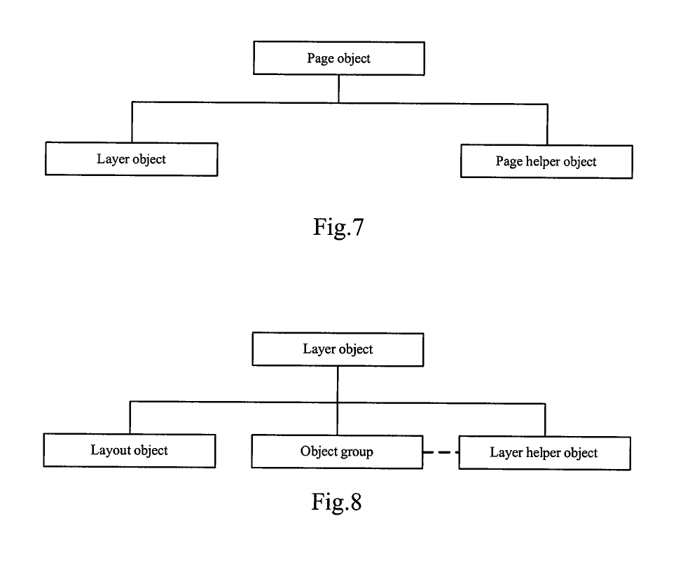

As shown in FIG. 7, every page object includes one or multiple layer objects and a random number of page helper objects. The page helper object includes a metadata object, digital signature object and history object.

As shown in FIG. 8, every layer object includes one or multiple layout objects, a random number of object groups and a random number of layer shared objects. The layer helper object includes a metadata object, digital signature object and history object. The object group includes a random number of layout objects, a random number of object groups and optional digital signature objects. When the object group includes multiple object groups, the structure of the object is similar to the structure of a folder including multiple folders in the Windows system.

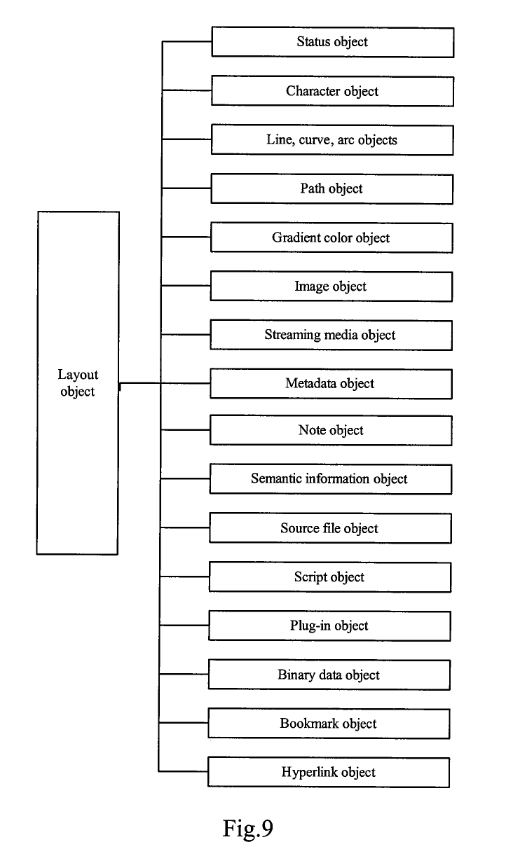

As shown in FIG. 9, the layout object includes a status object, character object, line object, curve object, arc object, path object, gradient color object, image object, streaming media object, metadata object, note object, semantic information object, source file object, script object, plug-in object, binary data stream object, bookmark object and hyperlink object.

Further the status object includes a random number of character set objects, typeface objects, character size objects, text color objects, raster operation objects, background color objects, line color objects, fill color objects, linetype objects, line width objects, line joint objects, brush objects, shadow objects, shadow color objects, rotate objects, outline typeface objects, stroke typeface objects, transparent objects and render objects.

The universal document model can be enhanced or simplified based on the above description practically. If a simplified document model does not include a docset object, the docbase object shall include a document object directly. And if a simplified document model does not include a layer object, the page object shall include a layout object directly.

A skilled in the art can understand that a minimum universal document model includes only a document object, page object and layout object. And the layout object includes only a character object, line object and image object. The models between a full model and the minimum model are included in the equivalents of the preferred embodiments of the present invention.

Furthermore, a universal document security model needs to be defined to satisfy the document security of various practical needs. The universal document security model shall cover and excel the universal document security models employed by applications in the prior art and the definition of the universal document security model covers items as follows.

1. Role Object

A role is defined in a docbase and a role object is created, and the role object is usually the sub-object of the docbase. When corresponding universal document model does not include a docbase object, the role shall be defined in a document, i.e., the role object shall be the sub-object of a document object and all docbases in the universal document security model shall be replaced with documents.

2. Grant an Access Privilege to a Specified Role

An access privilege for any role on any object (e.g. a docbase object, docset object, document object, page object, layer object, object group object and layout object) can be set up. If a privilege on an object is granted to a role, the privilege can be inherited by all sub-objects of the object.

Access privileges in the docbase management system may include any one or any combination of the following privileges on objects: read privilege, write privilege, re-license privilege (i.e., granting part of or all the privilege of itself to another role), and bereave privilege (i.e., deleting part of or all the privileges of another role). However, the privileges provided by the present invention are not limited to any one or any combinations of the privileges described above and more privileges can be defined, e.g., print prohibition.

3. Attach a Signature of Role to an Object

A signature of a role can be attached to an object. The signature covers the sub-objects of the object and objects referenced by the object.

4. Create a Role

A key of a role used for login process shall be returned in response to an instruction of creating a role object, the key is usually a private key of the PKI key pair and should be kept carefully by the application. The key also can be a login password. Preferably, all applications are allowed to create a new role to which no privilege is granted. Certain privileges can be granted to the new role by existing roles with re-license privilege.

5. Login of Role

When an application logs in as a role, the “challenge-response” mechanism can be employed, i.e., the docbase management system encrypts a random data block with the public key of the role and sends the encrypted data to the application, the application decrypts the data and returns the decrypted data to the docbase management system, if the data are correctly decrypted, it is determined that the application does have the private key of the role (the “challenge-response” authentication process may be repeated for several times for double-check). The “challenge-response” mechanism may also include processes as follows. The docbase management system sends a random data block to the application; the application encrypts the data with the private key and returns the encrypted data to the docbase management system, and the docbase management system decrypts the encrypted data with the public key, if the data is correctly decrypted, it is determined that the application does have the private key of the role. The “challenge-response” mechanism provides better security for the private key. When the key of the role is a login password, users of the application have to enter the correct login password.

In addition, the application may log in as multiple roles and the privileges granted to the application is the union of the privileges of the roles.

6. A Default Role

A special default role can be created. When a default role is created, the corresponding docbase can be processed with the default role even when no other role logs in. Preferably, a docbase creates a default role with all possible privileges when the docbase is created.

Practically the universal document security model can be modified into an enhanced, simplified or combined process, and the modified universal document security model is included in the equivalents of the embodiments of the present invention.

Practical Application of the Interface Layer

A unified interface standard for the interface layer can be defined based on the universal document model, universal security model and common document operations. And the interface standard is used for sending an instruction used for processing an object in the universal document model. The instruction used for processing an object in the universal document model is in compliance with the interface standard so that different applications may issue standard instructions via the interface layer.

The application of the interface standard is explained hereinafter. The interface standard can be performed through processes as follows. The upper interface unit generates an instruction string according to a predetermined standard format, e.g., “<UOML_INSERT (OBJ=PAGE, PARENT=123.456.789, POS=3)/>”, and sends the instruction to the lower interface unit, then receives the operation result of the instruction or other feedback information from the docbase management system via the lower interface unit. Or the interface standard can be performed through processes as follows. The lower interface unit provides a number of interface functions with standard names and parameters, e.g., “BOOL UOI_InsertPage (UOI_Doc *pDoc, int nPage)”, the upper interface unit invokes these standard functions and the action of invoking functions is equal to issuing standard instructions. Or the above two processes can be combined to perform the interface standard.

The interface standard applies an “operation action+object to be operated” approach so that the interface standard will be easy to study and understand and be more stable. For example, when 10 operations need to be performed on 20 objects, the standard can either define 20×10=200 instructions or define 20 objects and 10 actions. However, the latter definition method puts far less burden on human memory and it will be easy to add an object or action when the interface standard is extended in the future. The object to be operated is an object in the universal document model.

For example, the following 7 operation actions can be defined:

Open: create or open a docbase;

Close: close a session handle or a docbase;

Get: get an object list, object related attribute and data;

Set: set/modify object data;

Insert: insert a specified object or data;

Delete: delete a child object of an object;

Search: search for contents in document(s) according to a specified term, wherein the term may include accurate information or vague information, i.e., fuzzy search is supported.

The following objects can be defined: a docbase, docset, document, page, layer, object group, text, image, graphic, path (a group of closed or open graphics in an order), source file, script, plug-in, audio, video, role, etc.

The objects to be defined also include following status objects: background color, line color, fill color, line style, line width, ROP, brush, shadow, shadow color, character height, character width, rotate, transparent, render mode, etc.

When the interface standard applies the “operation action+object to be operated” approach, it can not be understood automatically that each combination of each object plus each action gives a meaningful operation instruction, some combinations are just meaningless.

The interface standard may also be defined by using a function approach which is not an “operation action+object to be operated” approach. For example, an interface function is defined for each operation on each object, and in such a case the upper interface unit issues an operation instruction by invoking corresponding interface function of the lower interface unit and sending the interface function to the docbase management system.

The interface standard may also encapsulate various object classes, e.g., a docbase class, and define an operation to be performed on the object as the method of the class.

Particularly, if an instruction of getting page bitmap is defined in the interface standard, it will be crucial to layout consistency and document interoperability.

By using the instruction of getting page bitmap, the application can get the page bitmap of a specified bitmap format in a specified page, i.e., the screen output of the page can be shown in a bitmap without separately rendering every layout object. That means the application can directly get accurate page bitmaps to display/print a document without reading every layout object on every layer in every page one by one, rendering every object or displaying the rendering of every object on page layout. When the application has to render the objects one by one, in practical some applications may provide comparatively full and accurate rendering of the objects while other applications provide only partial or inaccurate rendering of the objects, hence different applications may produce different screen display/print outputs for a same document, which impairs document interoperability among the applications. By generating page bitmaps by the docbase management system, the keypoint to keeping consistent page layout is transferred from the application to the docbase management system, which makes it possible for different applications to produce identical page output for a same document. The docbase management system can provide such a function because: firstly, the docbase management system is a unified basic technical platform and is able to render various layout objects while it will be hard for an application to render all layout objects; secondly, different applications may cooperate with a same docbase management system to further guarantee consistent layouts in screen display/print outputs. To sum up, it is unlikely for different applications to produce identical output for a same document while it is possible for different docbase management systems to produce identical output for a same document, and a same docbase management system will definitely produces identical output for a same document. Therefore the task of generating page bitmaps is transferred from the application to the docbase management system, and it is an easy way to keep consistent page bitmap among different applications for a same document. Furthermore, the instruction of getting page bitmap may target a specified area on a page, i.e., request to show only an area of a page. For example, when the page is larger than the screen, the whole page needs not to be shown, and while scrolling the page only the scrolled area needs to be re-painted. The instruction may also allow getting a page bitmap constituted of specified layers, especially a page bitmap constituted of a specified layer and all layers beneath the specified layer, such bitmaps will perfectly show history of the page, i.e., shows what the page looks like before the specified layer is added. If required, the instruction can specify the layers to be included in page bitmaps and the layers to be excluded from the page bitmaps.

An embodiment of the interface standard in the “operation action+object to be operated” approach is described hereafter. In the embodiment, the interface adopts the Unstructured Operation Markup Language (UOML) which provides an instruction in the Extensible Markup Language (XML). By generating a string in compliance with UOML format and sending the string to the lower interface unit, the upper interface unit sends an operation instruction to the docbase management system. The docbase management system executes the instruction and the lower interface units generates another string in UOML format according to the result of the operation in accordance with the instruction, the string is returned to the upper interface unit so that the application will learn the result of the operation in accordance with the instruction.

The result shall be expressed in UOML_RET and the definitions adopted in the UOML_RET include items as follows.

Attributes

SUCCESS: true indicating the successful operation and otherwise indicating the failing operation.

Sub-Elements

ERR_INFO: optional, appearing only when the operation fails and used for describing corresponding error information.

Other sub-elements: defined based on different instructions, checking description of the instructions for reference.

UOML actions include items as follows.

1. UOML_OPEN create or open a docbase

1.1 Attributes

1.1.1 create: true indicating creating a new docbase and otherwise indicating opening an existing docbase.

1.2 Sub-elements

1.2.1 path: a docbase directory path. It can be the name of a file in a disk, or a URL, or a memory pointer, or a network path, or the logic name of a docbase, or another expression that points to a docbase.

1.3 Return values

when the operation succeeds, a sub-element “handle” is added into the UOML_RET to record the handle.

2. UOML_CLOSE close

2.1 Attributes: N/A

2.2 Sub-elements

2.2.1 handle: an object handle, a pointer index of the object denoted by a string.

2.2.2 db_handle: a docbase handle, a pointer index of the docbase denoted by a string.

2.3 Return values: N/A

3. UOML_GET Get

3.1 Attributes

usage: any one of “GetHandle” (get the handle of a specified object), “GetObj” (get the data of a specified object) and “GetPageBmp” (get a page bitmap).

3.2 Sub-elements

3.2.1 parent: the handle of the parent object of an object, used only when the attribute “usage” contains a value for “GetHandle”.

3.2.2 pos: a position number, used only when the attribute “usage” contains a value for “GetHandle”.

3.2.3 handle: the handle of a specified object, used only when the attribute “usage” contains a value for “GetObj”.

3.2.4 page: the handle of the page to be displayed, used only when the attribute “usage” contains a value for “GetPageBmp”.

3.2.5 input: describing the requirements for an input page, e.g., requiring to display the contents of a layer or multiple layers (the present logged role must have the privilege to access the layer(s) to be displayed), or specifying the size of the area to be displayed by specifying the Clip area, used only when the attribute “usage” contains a value for “GetPageBmp”.

3.2.6 output: describing the output of a page bitmap, used only when the attribute “usage” contains a value for “GetPageBmp”.

3.3 Return values

3.3.1 when the attribute “usage” contains a value for “GetHandle” and the operation on the object succeeds, a sub-element “handle” is added into the UOML_RET to record the handle of the No. pos sub-element of the parent object.

3.3.2 when the attribute “usage” contains a value for “GetObj” and the operation on the object succeeds, a sub-element “xobj” is added into the UOML_RET to record the xml expression of the data which includes the handle object.

3.3.3 when the attribute “usage” contains a value for “GetPageBmp” and the operation on the object succeeds, a location is specified in the “output” sub-element to export a page bitmap.

4 UOML_SET Set

4.1 Attributes: N/A

4.2 Sub-elements

4.2.1 Handle: setting an object handle

4.2.2 xobj: description of an object;

4.3 Return values: N/A

5 UOML_INSERT Insert

5.1 Attributes: N/A

5.2 Sub-elements

5.2.1 parent: the handle of a parent object

5.2.2 xobj: description of an object

5.2.3 pos: the position of the inserted object

5.3 Return values

when the operation on an object succeeds, the object indicated by the “xobj” parameter shall be inserted into the parent object as the No. pos child object of the parent object and a “handle” sub-element shall be included in the UOML_RET to indicate the handle of the newly inserted object.

6. UOML_DELETE delete

6.1 Attributes: N/A

6.2 Sub-elements

6.2.1 handle: the handle of the object to be deleted

6.3 Return values: N/A

7. UOML_QUERY search

7.1 Attributes: N/A

7.2 Sub-elements

7.2.1 handle: the handle of the docbase to be searched for

7.2.2 condition: search terms

7.3 Return values

when the operation succeeds, a “handle” sub-element shall be included in the UOML_RET to indicate the handle of the search results, a “number” sub-element shall indicate the number of the search results and UOML_GET can be used for getting each search result.

UOML objects include a docbase (UOML_DOCBASE), a docset (UOML_DOCSET), a document (UOML_DOC), a page (UOML_PAGE), a layer (UOML_LAYER), an object group (UOML_OBJGROUP), a text (UOML_TEXT), an image (UOML_IMAGE), a line (UOML_LINE), a curve (UOML_BEIZER), an arc (UOML_ARC), a path (UOML_PATH), a source file (UOML_SRCFILE), a background color (UOML_BACKCOLOR), a foreground color (UOML_COLOR), a ROP(UOML_ROP), a character size (UOML_CHARSIZE) and a typeface (UOML_TYPEFACE).

The method for defining the objects is explained hereafter with reference to part of objects as follows.

1 UOML_DOC

1.1 Attributes: N/A

1.2 Sub-elements

1.2.1 metadata: metadata

1.2.2 pageset: pages

1.2.3 fontinfo: an embedded font

1.2.4 navigation: navigation information

1.2.5 thread: thread information

1.2.6 minipage: thumbnail image

1.2.7 signiture: a digital signature

1.2.8 log: history

1.2.9 shareobj: shared objects in the document

2 UOML_PAGE

2.1 Attributes

2.1.1 resolution: logical resolution

2.1.2 size: size of the page core, including a width value and a height value

2.1.3 rotation: rotation angle

2.1.4 log: history

2.2 Sub-elements

2.2.1 G: initial graphic statuses, including charstyle (character style), linestyle (line style), linecap (line cap style), linejoint (line joint style), linewidth (line width), fillrule (rule for filling), charspace (character space), linespace (line space), charroate (character rotation angle), charslant (character slant direction), charweight (character weight), chardirect (character direction), textdirect (text direction), shadowwidth (shadow width), shadowdirect (shadow direction), shadowboderwidth (shadow border width), outlinewidth (outline width), outlineboderwidth (outline border width), linecolor (line color), fillcolor (color for filling), backcolor (background color), textcolor (text color), shadowcolor (shadow color), outlinecolor (outline color), matrix (transform matrix) and cliparea (clip area)

2.2.2 metadata: metadata

2.2.3 layerset: layers of the page

2.2.4 signiture: digital signatures

2.2.5 log: history

3. UOML_TEXT

3.1 Attributes:

3.1.1 Encoding: encoding pattern of characters

3.2 Sub-elements

3.2.1 TextData: contents of the text

3.2.2 CharSpacingList: a list of the spacing values for characters with irregular space

3.2.3 StartPos: the starting position

4 UOML_CHARSIZE

4.1 Attributes

4.1.1 width: character width

4.1.2 height: character height

4.2 Sub-elements: N/A

5 UOML_LINE

5.1 Attributes

5.1.1 LineStyle: line style

5.1.2 LineCap: line cap style

5.2 Sub-elements

5.2.1 StartPoint: the coordinate of the starting point of the line

5.2.2 EndPoint: the coordinate of the ending point of the line

6. UOML_BEIZER

6.1 Attributes

6.1.1 LineStyle: line style

6.2 Sub-elements

6.2.1 StartPoint: the coordinate of the starting point of a Bessel curve

6.2.2 Control1_Point: first control point of the Bessel curve

6.2.3 Control2_Point: second control point of the Bessel curve

6.2.4 EndPoint: the coordinate of the ending point of the Bessel curve

7. UOML_ARC

7.1 Attributes

7.1.1 ClockWise: the direction of the arc

7.2 Sub-elements

7.2.1 StartPoint: the coordinate of the starting point of the arc

7.2.2 EndPoint: the coordinate of the ending point of the arc

7.2.3 Center: the coordinate of the center of the arc

8. UOML_COLOR

8.1 Attributes

8.1.1 Type: Color type, i.e., RGB or CMYK

8.2 Sub-elements

RGB mode

8.2.1 Red: red

8.2.2 Green: green

8.2.3 Blue: blue

8.2.4 Alpha: transparency

CMYK mode

8.2.5 Cyan: cyan

8.2.6 Magenta: magenta

8.2.7 Yellow: yellow

8.2.8 Black_ink: black

The definitions of the rest UOML objects can be deduced from the above description. When the application requests an operation in the docbase management system, corresponding UOML instruction will be generated based on corresponding UOML action and UOML object according to the XML grammar; and the application issues the operation instruction to the docbase management system by sending the UOML instruction to the docbase management system.

For example, the operation of creating a docbase can be initiated by the executing instruction:

<UOML_OPEN create=“true”>
<path val=“f:\\data\\docbase1.sep”/>
</UOML_OPEN>

And the operation of creating a docset can be initiated by the executing instruction:

```
<UOML_INSERT >
  <parent val= “123.456.789”/>
  <pos val=“1”/>
  <xobj>
    <docset/>
</xobj>
</UOML_INSERT>
```

It should be noted that, though UOML is defined with XML, standard XML formatted expressions such as “<?xml version=“1.0” encoding=“UTF-8”?>” and “xmlns:xsi=“http://www.w3.org/2001/XMLSchema-instance”” are omitted to simplify the instructions, however, those familiar with XML may add the expressions at will.

The instructions may also be defined in a language other than the XML, e.g., the instructions can be constructed like PostScript, and in such case the above instruction examples will be changed into:

1, “f:\\data\\docbase1.sep”, /Open

/docset, 1, “123.456.789”, /Insert

Instructions in other string formats may also be defined according to the same theory; the instructions may even be defined in a non-text binary format.

The instructions may also be defined in an approach other than the “action+object” approach. For example, every operation on every object can be expressed in an instruction, e.g., “UOML_INSERT_DOCSET” indicates inserting a docset and “UOML_INSERT_PAGE” indicates inserting a page, and the definition details are as follows:

UOML_INSERT_DOCSET: used for creating a docset in a docbase

Attributes: N/A

Sub-elements

parent: the handle of the docbase

pos: the position of the document-set to be inserted

return value: when the operation succeeds, a “handle” sub-element shall be included in the UOML_RET to indicate the handle of the newly inserted docset

Therefore the instruction shall appear like:

```
<UOML_INSERT_DOCSET >
  <parent val=“123.456.789”/>
  <pos val=“1”/>
</UOML_INSERT_DOCSET >
```

However, such approach for defining instructions is inconvenient since every legal operation on every object needs an independent instruction.

The interface standard can also apply an approach of invoking functions, i.e., the upper interface unit sends operation instructions to the docbase management system by invoking interface functions of the lower interface unit. The following embodiment of the interface, referred to as Unstructured Operation Interface (UOI), employs C++ language.

1. Define a UOI return value structure:

```
struct UOI_Ret {
  BOOL m_bSuccess; // whether the operation succeeds.
  CString m_ErrInfo; // when the operation fails, show error
  information.
};
```

Then, the basic classes of all UOI objects are defined.

```
  class UOI_Object {
  public:
    enum Type {
      TYPE_DOCBASE,
      TYPE_DOCSET,
      TYPE_DOC,
  TYPE_PAGE,
  TYPE_LAYER,
  TYPE_TEXT,
  TYPE_CHARSIZE,
      ......// the definitions of the types of other objects defined in the
universal document model are similar to the definitions described above
and will not be explained further.
    };
    Type m_Type;
    UOI_Object( );
  virtual ~ UOI_Object( );
  static UOI_Object *Create(Type objType); // create corresponding
object based on a specified type.
  };
```

2. Define UOI functions as follows in correspondence with the UOML actions in the embodiment of the “operation action+object to be operated” approach.

Open or create a docbase, and return the handle of the docbase in the “pHandle” if the operation succeeds:

UOI_RET UOI_Open (char *path, BOOL bCreate, HANDLE *pHandle).

Close the handle in the db_handle docbase, and if the handle value is NULL, the whole docbase will be closed:

UOI_RET UOI_Close (HANDLE handle, HANDLE db_handle).

Get the handle of a specified child object:

UOI_RET UOI_GetHandle (HANDLE hParent, int nPos, HANDLE *pHandle).

Get the type of the object pointed to by the handle:

UOI_RET UOI_GetObjType (HANDLE handle, UOI_Object::Type *pType).

Get the data of the object pointed to by the handle:

UOI_RET UOI_GetObj (HANDLE handle, UOI_Object *pObj).

Get a page bitmap:

UOI_RET UOI_GetPageBmp (HANDLE hPage, RECT rect, void *pBuf).

Set an object:

UOI_RET UOI_SetObj (HANDLE handle, UOI_Object *pObj).

Insert an object:

UOI_RET UOI_Insert (HANDLE hParent, int nPos, UOI_Object *pObj, HANDLE *pHandle=NULL).

Delete an object:

UOI_RET UOI_Delete (HANDLE handle).

Search, and the number of search results is returned in “pResultCount” while the handles of the search results are returned in “phResult”:

UOI_RET UOI_Query (HANDLE hDocbase, const char *strCondition, HANDLE *phResult, int *pResultCount).

3. Define various UOI objects. The following examples include UOI_Doc, UOI_Text and UOML_CharSize.

| class UOI_Doc : public UOI_Object { | |
|---|---|
| public: | |
| UOI_MetaData | m_MetaData; |
| int | m_nPages; |
| UOI_Page | **m_pPages; |
| int | m_nFonts; |
| UOI_Font | **m_pFonts; |
| UOI_Navigationm_Navigation ; | |
| UOI_Thread | m_Thread ; |
| UOI_MiniPage *m_pMiniPages ; | |
| UOI_Signature m_Signature ; | |
| int | m_nShared ; |
| UOI_Obj | *m_pShared; |

| UOI_Doc( ); | |
|---|---|
| virtual ~UOI_Doc( ) ; | |
| }; | |
| class UOI_Text : public UOI_Object { | |
| public: | |
| enum Encoding { | |
| ENCODE_ASCII, | |
| ENCODE_GB13000, | |
| ENCODE_UNICODE, | |
| ...... | |
| } ; | |
| Encoding | m_Encoding; |

| | |
|---|---|
| char | *m_pText ; |

| | |
|---|---|
| Point | m_Start ; |
| int | *m_CharSpace; |

```
UOI_Text( );
virtual ~ UOI_Text( );
};
class UOI_CharSize : public UOI_Object {
public:
  int m_Width;
  int m_Height;
  UOI_CharSize( );
  virtual ~UOI_CharSize( );
};
```

The way of applying the UOI is explained with reference to the following example. First a docbase shall be created:

ret=UOI_Open(“f:\\data\\docbase1.xsep”, TRUE, &hDocBase).

4. Construct a function used for inserting a new object.

| HANDLE InsertNewObj (HANDLE hParent, int nPos, | |
|---|---|
| UOI_Object ::Type type) | |
| { | |
| UOI_Ret | ret; |
| HADNLE | handle ; |
| UOI_Obj | *pNewObj = UOI_Obj::Create (type); |

```
if (pNewObj == NULL)
  return NULL;
ret = UOI_Insert(hParent, nPos, pNewObj, &handle) ;
delete pNewObj ;
return ret.m_bSuccess ? handle : NULL;
  }
```

5. Construct a function used for getting an object directly.

```
UOI_Obj *GetObj(HANDLE handle)
{
UOI_Ret ret;
UOI_Object ::Type type;
UOI_Obj *pObj;
ret = UOI_GetObjType(handle, &type);
if ( !ret. m_bSuccess )
  return NULL;
pObj = UOI_Obj::Create(type);
if (pObj == NULL)
  return NULL;
ret = UOI_GetObj(handle, pObj);
if ( !ret. m_bSuccess ) {
  delete pObj;
  return NULL;
}
return pObj;
}
```

The interface standard may also be defined by using the function approach which is not a “action+object” approach, e.g., an interface function is defined for every operation on every object, and in such a case an operation instruction of inserting a docset is sent to the docbase management system by the way that the upper interface unit invokes corresponding interface function of the lower interface unit, and the operation instruction sent to the docbase management system is as follows:

UOI_InsertDocset(pDocbase, 0).

The interface standard may also encapsulate varieties of object classes, e.g., docbase class, and defines the an operation to be performed on the object as a method of the class. e.g.:

```
  class UOI_DocBase : public UOI_Obj
  {
  public:
  /*!
```

| | |
|---|---|
| * \brief | Create a docbase |
| * \param szPath: | full path of the docbase |
| * \param bOverride: | whether the original file should be overwritten |
| * \return UOI_DocBase | the object |
| */ | |

```
    BOOL Create(const char *szPath, bool bOverride = false);
  /*!
```

| | |
|---|---|
| * \brief | open a docbase |
| * \param szPath: | full path of the docbase |
| * \return UOI_DocBase | the object |
| */ | |

```
    BOOL Open(const char *szPath);
  /*!
  * \brief Close a docbase
  * \param N/A
  * \return N/A
  */
    void Close( );
  /*!
  * \brief Get a role list
  * \param N/A
  * \return UOI_RoleList the object
  * \sa UOI_RoleList
  */
    UOI_RoleList GetRoleList( );
  /*!
```

| | |
|---|---|
| * \brief | save a docbase |
| * \param szPath: | save the full path of the docbase |
| * \return | N/A |
| */ | |

```
    void Save(char *szPath = 0);
  /*!
```

| | |
|---|---|
| * \brief | insert a docset |
| * \param nPos: | the position at which the docset shall be inserted |

```
  * \return UOI_DocSet the object
  * \sa UOI_DocSet
  */
    UOI_DocSet InsertDocSet(int nPos);
  /*!
```

| | |
|---|---|
| * \brief | get the docset corresponding to a specified index |
| * \param nIndex: | index number of the document list |

```
  * \return UOI_DocSet the object
  * \sa UOI_DocSet
  */
    UOI_DocSet GetDocSet(int nIndex);
  /*!
  * \brief total number of the retrieved docsets
  * \param N/A
  * \return the number of docsets
  */
    int GetDocSetCount( );
  /*!
  * \brief set the name of the docbase
  * \param nLen: length of the docbase name
  * \param szName: docbase name
  * \return N/A
  */
    void SetName(int nLen, const char* szName);
  /*!
  * \brief get the length of the docbase name
  * \param N/A
  * \return length
  */
    int GetNameLen( );
  /*!
  * \brief get the docbase name
  * \param N/A
  * \return docbase name
  */
    const char* GetName( );
  /*!
  * \brief get the length of the docbase id
  * \param N/A
  * \return length
  */
    int GetIDLen( );
  /*!
  * \brief get the docbase id
  * \param N/A
  * \return id
  */
    const char* GetID( );
    //! Constructor function
    UOI_DocBase( );
    //! Destructor function
    virtual ~UOI_DocBase( );
  };
  class UOI_Text : public UOI_Obj
  {
  public:
    //! Constructor function
    UOI_Text( );
    //! Destructor function
    virtual ~UOI_Text( );
    //! Enumeration type indicating the text encoding pattern
    enum UOI_TextEncoding
    {
      CHARSET_ASCII,
      CHARSET_GB13000,
      CHARSET_UNICODE,
      };
    //! Get the encoding pattern of the text
    UOI_TextEncoding GetEncoding( );
    //! Set the encoding pattern of the text
    void SetEncoding(UOI_TextEncoding nEncoding );
    //! Get the text data
    const char * GetTextData( );
    //! Get the length of the text data
    int GetTextDataLen( );
    //! Set the text data
    /*!
    \param pData // text data
    \param nLen // data length
    */
    void SetTextData(const char * pData, int nLen);
    //! Get the startpoint
    Point GetStartPoint( );
    //! Set the startpoint
    void SetStartPoint(Point startPoint);
    //! Get the size of a character spacing list
    int GetCharSpacingCount( );
    //! Get the character spacing of the position specified in the character spacing list
    float GetCharSpacing(int nIndex);
    //! Set the size of character spacing list
    bool SetCharSpacingCount(int nLen);
    //! Set character spacing
    bool SetCharSpacing (int nIndex, float charSpace );
    //! Get the border of the text
    UOI_Rect GetExtentArea( ) ;
  };
  class UOI_RoleList : public UOI_Obj
  {
  public:
    //! Get the role number in the list
    int GetRoleCount( );
    //! Get a role according to a specified index
    UOI_Role *GetRole(int nIndex);
    //! Create a role
    /*!
    \param pPrivKey Private key cache
    \param pnKeyLen Return the length of the actual private key
    \return the newly created role
    */
    UOI_Role AddRole(unsigned char *pPrivKey, int *pnKeyLen);
    //! Constructor function
    UOI_RoleList( );
    //! Destructor function
    virtual ~UOI_RoleList( );
  };
  class UOI_Role : public UOI_Obj
  {
  public:
    //! Constructor function
    UOI_Role( );
    //! Destructor function
    virtual ~UOI_Role( );
    //! Get a role ID
    int GetRoleID( );
    //! Set a Role ID
    /*!
    \param nID role ID
    */
    void SetRoleID(int nID);
    //! Get a role name
    const char * GetRoleName( );
    //! Set a role name
    /*!
    \param szName Role name
    */
    void SetRoleName(const char *szName);
  };
  class UOI_PrivList : public UOI_Obj // privilege list
  {
  public:
    //! Get the privilege of a specified role
    UOI_RolePriv *GetRolePriv (UOI_Role *pRole);
    //! Create a privilege item for a role
    UOI_RolePriv *pPriv AddRole ( );
    //! Get the number of the privileges of a role in the list
      int GetRolePrivCount( );
    //! Get the privilege item of the role according to an index value
    UOI_RolePriv *GetRolePriv (int nIndex);
    //! Constructor function
    UOI_PrivList( );
    //! Destructor function
    virtual ~UOI_PrivList( );
  };
  class UOI_RolePriv : public UOI_Obj // corresponding to all privileges of a role
  {
  public:
    //! Get a role
    UOI_Role *GetRole( );
  //! Set privileges on an object; when the privileges exceed the present privileges of
the role on the object, the action constitutes granting the privileges, and when the
privileges are narrower than the present privileges of the role on the object, the action
constitutes bereaving of the privileges. The currently logged role must have the
corresponding re-license privilege or bereave privilege.
  bool SetPriv(UOI_Obj *pObj, UOI_Priv *pPriv);
  //! Get the number of granted privileges
  int GetPrivCount( );
    //! Get the object on which the privilege corresponding to the index value is
granted
    UOI_Obj *GetObj(int nIndex);
    //! Get the privilege set by the privileges corresponding to the index value
    UOI_Priv *GetPriv(int nIndex);
  //! Get the privilege on an object
  UOI_Priv *GetPriv(UOI_Obj *pObj);
  //! Constructor function
  UOI_RolePriv ( );
  //! Destructor function
  virtual ~UOI_RolePriv ( );
};
class UOI_Priv : public UOI_Obj
{
public:
enum PrivType { // definition of privilege types
  PRIV_READ, // read privilege
  PRIV_WRITE, // write privilege
  PRIV_RELICENSE, // relicense privilege
  PRIV_BEREAVE, //bereave privilege
  PRIV_PRINT, // print privilege
  Definitions of other privileges
}
  //! Whether there is a corresponding privilege being granted
  bool GetPriv(PrivType privType);
  //! Set the corresponding privilege
  void SetPriv(PrivType privType, bool bPriv);
//! Constructor function
  UOI_Priv ( );
  //! Destructor function
  virtual ~UOI_Priv ( );
};
class UOI_SignList : public UOI_Obj
{
public:
  //! Constructor function
  UOI_SignList( );
  //! Destructor function
  virtual ~UOI_SignList( );
  //! Add a new node signature and return the index value thereof
  int AddSign(UOI_Sign *pSign);
  //! Get a node signature according to a specified index value
  UOI_Sign GetSign(int index);
  //! Delete a node signature according to a specified index value
  void DelSign(int index);
  //! Get the number of the node signatures in the list
  int GetSignCount( );
};
class UOI_Sign : public UOI_Obj
{
public:
  //! Constructor function
  UOI_Sign( );
  //! Destructor function
  virtual ~UOI_Sign( );
  //! Perform the action of signing
  /*!
  \param pDepList the dependency list of the signature
  \param pRole the role that signs
  \param pObj the object on which the signature is created
  */
  void Sign(UOI_SignDepList pDepList, UOI_Role pRole , UOI_Obj pObj);
  //! Verify the signature
  bool Verify( );
  //! Get the dependency list of the signature
  UOI_SignDepList GetDepList( );
};
class UOI_SignDepList : public UOI_Obj
{
public:
  //! Constructor function
  UOI_SignDepList( );
  //! Destructor function
  virtual ~UOI_SignDepList( );
  //! Insert a dependency item
  void InsertSignDep(UOI_Sign *pSign);
  //! The number of the dependency item got
  int GetDepSignCount( );
  //! Get a dependency item according to a specified index
  UOI_Sign * GetDepSign(int nIndex);
};
```

The upper interface unit sends an operation instruction of inserting a docset to the docbase management system by invoking a function of the lower interface unit in following method: pDocBase.InsertDocset(0).

Different interface standards can be designed in the same way as described above for applications developed based on Java, C#, VB, Delphi or other languages.

As long as an interface standard includes no feature associated with a certain operation system (e.g., WINDOWS, UNIX/LINUX, MAC OS, SYMBIAN) or hardware platform (e.g., x86CPU, MIPS, POWER PC), the interface standard can be applied across platforms so that different applications and docbase management systems on different platforms can use a same interface standard, even an application running on one platform may invoke a docbase management system running on another platform to proceed an operation. For example, when the application is installed on a client terminal in a PC using Windows OS and the docbase management system is installed on a server in a mainframe using Linux OS, the application can still invoke the docbase management system on the server to process documents just like invoking a docbase management system on the client terminal.

When the interface standard includes no feature associated with a certain program language, the interface standard is further free from dependency on the program language. It can be seen the instruction string facilitates the creation of a more universal interface standard irrelevant to any platform or program language, especially when the instruction string is in XML, because all platforms and program languages in the prior art have easy-to-get XML generating and parsing tools, therefore the interface standard will perfectly fit all platforms and be independent of program languages, and the interface standard will make it more convenient for engineers to develop an upper interface unit and lower interface unit.

More interface standards can be developed based on the same way of defining the interface standard described above.

More operation instructions can be added into the interface standard based on the embodiments described above in the way of constructing instructions as described above, and the operation instructions can also be simplified based on the embodiments, especially when the universal document model is simplified, the operation instructions shall be simplified accordingly. The interface standard shall include at minimum the operation instructions for creating a document, creating a page and creating a layout object.

The working process of the document processing system in accordance with the present invention is explained with reference to FIG. 1 again.

The application may include any software of an upper interface unit in compliance with the interface standard, e.g., the Office software, contents management application, a resource collection application, etc. The application sends an instruction to the docbase management system when the application needs to process a document, and the docbase management system performs corresponding operation according to the instruction.

The docbase management system may store and organize the data of the docbase in any form, e.g., the docbase management system may save all files in a docbase in a file on a disk, or create one file on the disk for one document and organize the documents by using the file system functions of the operating system, or create one file on the disk for one page, or allocate room on disk and manage the disk tracks and sectors without referencing to the operating system. The docbase data can be saved in a binary format, in XML, or in binary XML. The page description language (used for defining objects including texts, graphics and images in a page) may adopt PostScript, or PDF, or SPD, or a customized language. To sum up, any definition method that enables the interface standard to achieve the functions described herein is acceptable.

For example, the docbase data can be described in XML and when the universal document model is hierarchical, an XML tree can be built accordingly. An operation of creating adds a node in the XML tree and an operation of deleting deletes a node in the XML tree, an operation of setting sets the attributes of corresponding node and an operation of getting gets the attributes of corresponding node and returns the attribute information to the application, and an operation of searching traverses all related nodes. A further description of an embodiment is given as follows.

1. XML is used for describing every object; therefore an XML tree is created for every object. Some objects show simple attributes and the XML trees corresponding to the objects will have only the root node; some objects show complicate attributes and the XML trees corresponding to the objects will have root node and children nodes. The description of the XML trees can be created with reference to the XML definitions of the operation objects given in the fore-going description.

2. When a new docbase is created, a new XML file which root node is the docbase object shall be created.

3. When a new object (e.g., a character object) is inserted into the docbase, the XML tree corresponding to the new object shall be inserted under corresponding parent node (e.g., a hierarchy). Therefore every object in the docbase corresponds to a node in the XML tree whose root node is the docbase.

4. When an object is deleted, the node corresponding to the object and the children nodes thereof shall be deleted. The deletion starts from a leaf node in a tree traversal from the bottom to the top.

5. When an attribute of an object is set, the attribute of the node corresponding to the object shall be set to the same value. If the attribute is expressed as an attribute of a child node, the attribute of the corresponding child node shall be set to the same value.

6. In the process of getting an attribute of an object, the node corresponding to the object shall be accessed and the attribute of the object is got according to the corresponding attribute and child nodes of the node.

7. In the process of getting the handle of an object, the XML path of the node corresponding to the object shall be returned.

8. When an object (e.g., a page) is copied to a specified position, the whole subtree starting from the node corresponding to the object shall be copied to a position right under the parent node corresponding to the specified position (e.g., a document). When the object is copied to another docbase, the object referenced to by the subtree (e.g., an embedded font) shall also be copied.

9. In the process of performing an instruction of getting layout information, a blank bitmap in a specified bitmap format is created firstly in the same size of the specified area, then all layout objects of the specified page are traversed, every layout object in the specified area (including the objects which have only parts in the area) is rendered and displayed in the blank bitmap. The process is complicated and can be performed by those skilled in the art, however, the process is still covered by the RIP technology in the prior art and will not be described herein.

10. When a role object is created, a random PKI key pair (e.g., 512-digits RSA keys) is generated, the public key of the PKI key pair is saved in the role object and the private key is returned to the application.

11. When the application logs in, a random data block (e.g., 128 bytes) is generated, and encrypted with the public key of the corresponding role object and sent to the application, the application decrypts the encrypted data block and the decrypted data block shall be authenticated, if the data block is correctly decrypted, the application is proved to possess the private key of the role and will be allowed to log in. Such authentication process may be repeated for three times and the application is allowed to log in only when the application passes all three authentication processes.

12. When signature is attached to a target object, the signature shall be attached to the subtree starting from the node corresponding to the object. The subtree shall be regularized first so that the signature will be free from being affected by physical storage variation, i.e., by logically equivalent alterations (e.g., changes of pointer caused by the changes of storage position). The regularization method includes:

traversing all nodes in the subtree whose root node is the target object (i.e., target object and the sub-object thereof) in a depth-fist traversal, regularizing each node in the order of the traversal and joining the regularization result of each node.

The regularization of a node in the subtree includes: calculating the HASH value of the children node number of the node, calculating the HASH values of the node type and node attributes, joining the obtained HASH values of the node type and node attributes right behind the HASH value of the children node number according to the predetermined order, and calculating the HASH value of the join result to obtain the regularization result of the node. When the signature also needs to be attached to an object referenced to by a node in the subtree, the object shall be regarded as a child node of the node and be regularized in the method described above.

After the regularization, the HASH value of the regularization can be generated and the signature can be attached with the private key of the role according to the techniques in the prior art which will not be described herein.

In the regularization process, the regularization of a node in the subtree may also include: joining the children node number of the node, the node type and node attributes in an order with separators in between, calculating the HASH value of the join result to obtain the regularization result of the node. Or the regularization of a node in the subtree may include: joining the children node number length, the node type length and the node attribute lengths in an order with separators in between, further joining the already joint lengths with the children node number, node type and node attributes, then the regularization result of the node is obtained. To sum up, the step of regularizing a node in the subtree may include the following step: joining original values or transformed values (e.g., HASH values, compressed values) of: the children node number, node type and node attributes, and the lengths of the children node number/node type/node attributes (optional), in a predetermined order directly or with separators in between.

The predetermined order includes any predetermined order of arranging the children node number length, node type length, node attribute lengths, children node number, node type and node attributes.

In addition, either depth-first traversal or width-first traversal is applied in the traversal of the nodes in the subtree.

It is easy to illustrate various modifications of the technical scheme of the present invention, e.g., the scheme may include joining the children node number of every node with separators in between in the order of depth-first traversal and the joining with the regularization results of other data of every node. Any method that arranges the children node numbers, node types and node attributes of all nodes in the subtree in a predetermined order constitutes a modification of this embodiment.

13. When setting a privilege on an object, the simplest method includes: recording the privileges of all roles on the object (including the sub-objects thereof) and comparing the privileges of the roles when the roles log in, if operations within the privileges, the operations shall be accepted, otherwise error information shall be returned. A preferred method applied to the present invention includes: encrypting corresponding data and controlling privileges with keys, when a role cannot present correct keys, the role does not have corresponding privilege. This preferred method provides better anti-attack performance. The detailed description of the steps of the preferred method is given below.

a) A PKI key pair is generated for a protected data sector (usually a subtree corresponding to an object and the sub-objects thereof), and the data sector is encrypted with the encryption key of the PKI key pair.
b) When a role is granted read privilege, the decryption key of the PKI key pair is passed to the role and the role may decrypt the data sector with the decryption key in order to read the data correctly.
c) When a role is granted write privilege, the encryption key of the key PKI pair is passed to the role and the role may encrypt modified data with the decryption key in order to write data into the data sector correctly.
d) Since the encryption/decryption efficiency of the PKI keys is low, a symmetric key may be used for encrypting the data sector and the encryption key further encrypts the symmetric key while the decryption key may decrypts the encrypted symmetric key data to retrieve the correct symmetric key. The encryption key may be further used for attaching a digital signature to the data sector to prevent a role with the read privilege only from modifying the data when the role is given the symmetric key. In such a case a role with the write privilege attaches a new signature to the data sector every time when the data sector is modified; therefore the data will not be modified by any role without the write privilege.
e) When a role is given the encryption key or decryption key, the encryption key or decryption key may be saved after being encrypted by the public key of the role, so that the encryption key or decryption key can only be retrieved with the private key of the role.

In this embodiment, the system and method for document data security management provided by the present invention are applied to the docbase management system described in the fore-going description; however, the present invention can also be applied to any system other than the docbase management system.

The system for document data security management provided by the present invention is explained herein first.

The system for document data security management of the present invention includes a role management unit, a security session channel unit, an identity authentication unit, an access control unit and a signature unit. The role management unit is used for managing at lease one role and has the functions of creating a role, granting a privilege to a role and bereaving a role of a privilege. A role can be identified with at least one unique ID and one unique PKI key pair, however, the role object saves only the ID and the public key of the role, the private key of the role is given to the application. The role can also be identified with a unique ID and a login password, and in such a case the role object saves only the ID and the encrypted login password. The ID of a role can be any number or string as long as different roles are given different IDs. The PKI algorithm can be either ECC algorithm or RSA algorithm.

A number of roles are defined in a docbase and the role objects are sub-objects of the docbase. When corresponding universal document model does not include a docbase object, the roles shall be defined in documents, i.e., the role objects shall be the sub-objects of document objects and all docbases in the document data security management system shall be replaced with documents.

Preferably, all applications are allowed to create a new role to which no privilege is granted. Certain privileges can be granted to the new role by existing roles with re-license privilege.

The key returned in response to an instruction of creating a role object shall be used for login process, the key should be kept carefully by the application, and the key is usually a private key of a PKI key pair or a login password.

A special default role can be created in the system for document data security management. When a default role is created, corresponding docbase can be processed with the default role even when no other roles log in. Preferably, a docbase creates a default role with all possible privileges when the docbase is created.

The process performed by the application from using a role (or roles) to log in so as to performing a number of operations and to logging out is regarded as a session. A session can be identified with session identification and a logged role list. The session can be performed on a security session channel in the security session channel unit which keeps at least a session key for encrypting the data transmitted on the security session channel. The session key may be an asymmetric key, or a commonly used symmetric key with more efficiency.

The identity authentication unit is used for authenticating the identity of a role when the role logs in. The identity authentication is role oriented and any role except the default role may log in only after presenting the key of the role. When a role wants to log in and the key of the role is a PKI key, the identity authentication unit retrieves the public key of the role from the role object according to the role ID and authenticates the identity of the role by using the “challenge-response” mechanism described in the fore-going description; when the key of the role is a login password, the identity authentication unit retrieves the public key of the role from the role object according to the role ID and draws comparison.

The application may log in as multiple roles at the same time and the privileges granted to the application shall then be the union of the privileges of the roles.

The access control unit is used for setting an access control privilege for document data, and a role can only access document data according to the access control privilege granted to the role. The privilege data can be managed by the access control unit so that some roles may acquire the privilege of other role and some roles may not. A role can modify privileges of other roles in normal re-license or bereave process only when the role is granted re-license privilege or bereave privilege; directly writing data into the privilege data is not allowed.

An access privilege for any role on any object (a docbase, docset, document, page, layer, object group, layout object) can be set up, and if a privilege on an object is granted to a role, the privilege can be inherited by all sub-objects of the object.

Access privileges include any one or any combination of the following privileges: read privilege (whether a role may read data), write privilege (whether a role may write into data), re-license privilege (whether a role may re-license, i.e., grant part of or all the privileges of the role to another role), bereave privilege (whether a role may bereave of privilege, i.e., delete a part or all of the privileges of another role) and print privilege (whether a role may print data), and the present invention does not limit the privileges. Preferably, a docbase creates a default role with all possible privileges when the docbase is created so that the creator of the docbase has all privileges on the docbase.

The signature unit is used for attaching a signature to any logical data specified among the document data in the system for document data security management. A role signature can be attached by the signature unit with corresponding private key and the validity of the role signature on the logical data can be verified with the public key.

The role signature can be attached to all objects. The signature covers the sub-objects of the signed object and the objects referenced by the signed object.

The method for document data security management is further explained herein with reference to the system for security management described above.

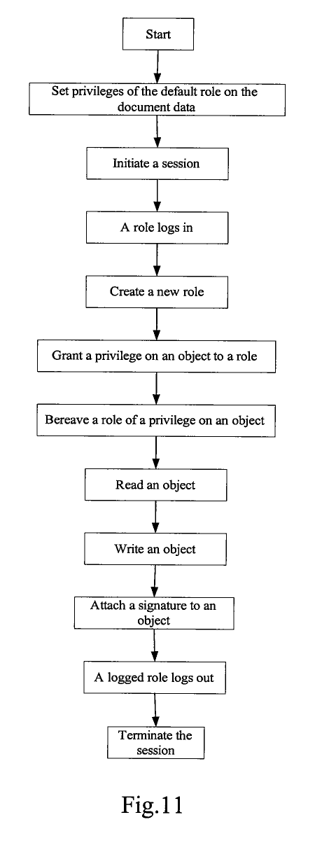

As shown in FIG. 11, the method for document data security management of the present invention includes the following steps:

1. When a docbase is created, the role management unit automatically grants all possible privileges on the docbase, including read privilege, write privilege, re-license privilege and bereave privilege on all objects, to the default role of the docbase.

2. The security session channel unit sets up a security session channel between the application and the docbase management system and initiates a session.

a) Determine whether the session has been successfully initiated according to session identification; if the session has been successfully initiated, the security session channel setup process shall end, otherwise the security session channel setup process shall proceed.

b) Either the application or the docbase management system generates a random PKI key pair.

c) The party which generates the random PKI key pair sends the public key of the PKI key pair to the other party.

d) The other party generates a random symmetric key as the session key, encrypts the session key with the public key and sends the encrypted session key to the party which generates the random PKI key pair.

e) The party which generates the random PKI key pair decrypts the encrypted session key with the private key of the PKI key pair.

f) Set up session identification.

g) Set the logged role list as the default role.

3. Role logs in

a) The application provides the ID of a role that shall log in and a docbase in which the role shall log.

b) The identity authentication unit checks the logged role list of the session, if the role (including the default role) has logged in, this step shall end, otherwise this step shall proceed.

c) when the key of the role is a PKI key, the identity authentication unit retrieves the public key of the role from the role object; when the key of the role is a login password, proceed Step h) directly.

d) The identity authentication unit generates a random data block and encrypts the data block with the public key of the role.

e) The identity authentication unit sends the encrypted data block to the application.

f) The application decrypts the encrypted data block with the private key of the role and sends the decrypted data back to the identity authentication unit.

g) The identity authentication unit checks whether the returned data is correct, and if the data is incorrect, the role will fail to log in, otherwise directly proceed Step i).

h) The application provides a login password and the identity authentication unit compares the login password saved in the role object with the login password provided by the application, if the two passwords are identical, the login process shall proceed; otherwise the role will fail to log in.

i) Add the role into the logged role list of the session.

4. Create a new role

a) The application issues an instruction of creating a new role.

b) The role management unit generates a unique role ID.

c) When the instruction requires the key of the to-be-created role to be a PKI key, the role management unit generates a random PKI key pair; when the instruction requires the key of the to-be-created role to be a login password, the login password of the role shall be the password specified by the instruction or generated at random by the role management unit.

d) The role management unit creates a role object in the docbase and saves the ID and the key (the public key or login password) in the role object, and the privilege of the role is null, i.e., the role has no privilege on any object.

e) Return the ID and the key (the private key or login password) to the application.

5. Grant a privilege P on an object O to a role R

When granting a privilege on an object, the simplest method includes: recording the privileges of each role on the object (including the sub-objects thereof) and comparing the privileges of each role when the role log in, if an operation within the privileges, the operation shall be accepted, otherwise error information shall be returned. A preferred method applied to the present invention includes: encrypting corresponding data and controlling privileges with a key, when a role cannot present a correct key, the role does not have corresponding privilege. This preferred method provides better anti-attack performance.

a) The application sends a privilege request.

b) The role management unit obtains the union of the privileges of all roles in the logged role list on the object O and determines whether the union is a superset of the privilege P and whether the union includes re-license privilege. If the union is a superset of the privilege P and the union includes the re-license privilege, the process shall proceed, otherwise the granting of the privilege will fail (because the privileges of all the roles still do not include a privilege used for granting).

c) The role management unit adds the privilege P on the object O into the privilege list of the role R. If the privilege P does not include read or write privilege, the privilege granting process is completed, otherwise the process continues.

d) The access control unit checks whether read/write access control privilege is set up on the object O. If no read/write access control privilege is set up on the object O, steps as follows shall be performed.
i. Generate a random symmetric key and a random PKI key pair.
ii. Encrypt the object O with the symmetric key; if the read/write access control privilege is set up on a subobject of the object O, the subobject shall remain unchanged.

A PKI key pair shall be generated for a data sector to be protected (usually a subtree corresponding to an object and the subobjects thereof), and the data sector is encrypted with the encryption key of the PKI key pair.
iii. Encrypt the symmetric key with the encryption key of the PKI key pair, save the encryption word and sign the target object to obtain a signature.
iv. Check all roles in the docbase. If a role has read privilege on object O (here the object O may be a subobject of the object on which the role has the read privilege), the decryption key shall be encrypted with the public key of the role and encryption word of the decryption key is saved in the privilege list of the role. If a role has write privilege on object O (here the object O may be a subobject of the object on which the role has the write privilege), the encryption key shall be encrypted with the public key of the role and encryption word of the encryption key is saved in the privilege list of the role.
v. Proceed Step h).

e) Choose a role that has needed privilege (the read privilege or write privilege) on the object O from all logged roles.

f) Obtain the encryption word of a corresponding key corresponding to the object O from the privilege list of the role (the read privilege requires the decryption key and the write privilege requires the encryption key, the combination of the read privilege and write privilege requires both keys), if the key of the role is a PKI key, the encryption word of the corresponding key is sent to the application and Step g) is performed; if the key of the role is a login password, the access control unit decrypts the encryption word of the corresponding key and then Step h) is performed.

When a role is granted the read privilege, the decryption key of the PKI key pair is passed to the role and the role may decrypt the data sector with the decryption key to read the data correctly. When a role is granted the write privilege, the encryption key of the PKI key pair is passed to the role and the role may encrypt modified data with the encryption key in order to write data into the data sector correctly.

g) The application decrypts encryption word of the corresponding key with the private key of the role to retrieve the key and returns the key to the access control unit.

h) The access control unit encrypts corresponding key according to the privilege P, generates corresponding encryption word of the corresponding key and saves the encryption word into the privilege list of the role R.

When a role is given an encryption key or decryption key, the encryption key or decryption key may be saved after being encrypted with the public key of the role, so that the encryption key or decryption key can only be retrieved with the private key of the role.

Since the encryption/decryption efficiency of the PKI keys is low, a symmetric key may be used for encrypting the data sector and the encryption key further encrypts the symmetric key while the decryption key may decrypt the encrypted key data to retrieve the correct symmetric key. The encryption key may be further used for attaching a digital signature to the data sector to prevent a role with read privilege only from modifying the data when the role is given the symmetric key. In such case a role with write privilege attaches a new signature to the data sector every time when the data sector is modified; therefore the data will not be modified by any role without write privilege.

6. Bereave a role R of a privilege P on an object O

a) The application sends a request of bereaving of a privilege.

b) The role management unit checks all roles in the logged role list to determine whether there is a role has a bereave privilege on the object O. If no role has the bereave privilege, the process of bereaving of the privilege will fail, otherwise the process continues.

c) Delete the privilege P from the privileges of the role R on the object O.

d) If the privilege P includes read or write privilege, corresponding decryption key or encryption key for the object O shall be removed from the privilege list of the role R.

7. Read an object O

a) The application sends an instruction of reading the object O.

b) The access control unit checks the privileges of all roles in the logged role list on the object O and determines whether there is at least one role in the logged role list has read privilege on the object O. If no role has the read privilege, the reading process fails; otherwise the process continues.

c) Check whether read/write access control privilege is set up on the object O. If no read/write access control privilege is set up, check the parent object of the object O and the parent object of the parent object until an object with the read/write access control privilege is found.

d) Choose a role that has the read privilege on the found object.

e) Extract the encryption word of the decryption key of the found object from the privilege list of the role, when the key of the role is a PKI key, the encryption word of the decryption key is sent to the application and Step f) is performed; when the key of the role is a login password, the access control unit decrypts the encryption word of the decryption key and Step g) is performed.

f) The application decrypts the encryption word of the decryption key with the private key of the role to retrieve the decryption key and returns the decryption key to the access control unit.

g) The access control unit decrypts encryption word of the symmetric key of the object with the decryption key to retrieve the symmetric key of the object.

h) Decrypt encryption word of the data of the object O with the symmetric key to retrieve the data of the object O.

i) Return the decrypted data of the object O to the application.

8. Write an object O

a) The application sends an instruction of writing into the object O.

b) The access control unit checks the privileges of all roles in the logged role list on the object O and determines whether there is at least one role in the logged role list has write privilege on the object O. If no role has the write privilege, the writing process fails, otherwise the process continues.

c) Check whether read/write access control privilege is set up on the object O. If no read/write access control privilege is set up, check the parent object of the object O and the parent object of the parent object until an object O1 with the read/write access control privilege is found.

d) Choose a role that has the write privilege on the object O1.

e) Extract the encryption word of the encryption key of the object O1 from the privilege list of the role. When the key of the role is a PKI key, the encryption word of the encryption key is sent to the application and Step f) is performed. When the key of the role is a login password, the access control unit decrypts the encryption word of the encryption key and Step g) shall be performed.

f) The application decrypts the encryption word of the encryption key with the private key of the role to retrieve the encryption key of the object O1 and returns the encryption key of the object O 1 to the access control unit.

g) Encrypt modified data of the object O with the encryption key of the object O1 (if read/write access control privilege is set up on a subobject of the object O, the subobject is encrypted with the original key of the subobject).

h) Overwrite the original data with the encrypted data and the writing process shall end.

9. Sign an object O to obtain a signature

a) The application sends an instruction of signing an object O to obtain a signature.

b) The access control unit regularizes the data of the object O.

When a signature is attached to an object, the signature shall be attached to the subtree starting from the node corresponding to the object. The regularization should be done first so that the signature will be free from being affected by physical storage variation, i.e., by logically equivalent alterations (e.g., change of pointer caused the change of storage position). The regularization method is given in the fore-going description.

c) Calculate HASH value of the regularization result.

d) Send the HASH value to the application.

e) The application encrypts the HASH value with the private key of the role (i.e., the signature) when the key of the role in the logged role list is a PKI key.

f) The application returns the signature result to the access control unit

g) The access control unit saves the signature result in a digital signature object.

10. log out a logged role

a) The application sends an instruction for logging out a logged role.

b) The security session channel unit deletes the logged role from the logged role list if the logged role list includes the logged role.

11. Terminate session

a) Either the application or the docbase management system sends a session termination request.

b) The security session channel unit terminates all threads related to the present session, erases the session identification and deletes the logged role list.

The following is an embodiment of the method for document data security management of the present invention applied on a computer.

```
  class UOI_RoleList : public UOI_Obj
  {
  public:
  //! Get the role number in the list
  int GetRoleCount( );
  //! Get a role according to a specified index
  UOI_Role *GetRole(int nIndex);
  //! Creat a role
  /*!
```

| | |
|---|---|
| \param pPrivKey | Private key cache |
| \param pnKeyLen | Return the length of the actual private key |
| \return | the newly created role |
| */ | |

```
  UOI_Role AddRole(unsigned char *pPrivKey, int *pnKeyLen);
  //! Constructor function
  UOI_RoleList( );
  //! Destructor function
  virtual ~UOI_RoleList( );
  };
  class UOI_Role : public UOI_Obj
  {
  public:
  //! Constructor function
  UOI_Role( );
  //! Destructor function
  virtual ~UOI_Role( );
  //! Get a role ID
  int GetRoleID( );
  //! Set Role ID
  /*!
    \param nID a role ID
    */
    void SetRoleID(int nID);
    //! Get a role name
    const char * GetRoleName( );
    //! Set a role name
    /*!
    \param szName Role name
    */
    void SetRoleName(const char *szName);
  };
  class UOI_PrivList : public UOI_Obj // privilege list
  {
  public:
    //! Get the privilege of a specified role
    UOI_RolePriv *GetRolePriv (UOI_Role *pRole);
    //! Create a privilege item for a role
    UOI_RolePriv *pPriv AddRole ( );
    //! Get the number of the privileges of a role in the list
    int GetRolePrivCount( );
    //! Get the privilege item of the role according to an index value
    UOI_RolePriv *GetRolePriv (int nIndex);
    //! Constructor function
    UOI_PrivList( );
    //! Destructor function
    virtual ~UOI_PrivList( );
  };
  class UOI_RolePriv : public UOI_Obj // all privileges of a role
  {
  public:
    //! Get a role
    UOI_Role *GetRole( );
  //! Set privileges on an object; when the privileges exceed present
privileges of the role on the object, the action constitutes granting the
privileges, and when the privileges are narrower than present privileges
of the role on the object, the action constitutes bereaving of the
privileges. The currently logged role must have the corresponding
re-license privilege or bereave privilege.
  bool SetPriv(UOI_Obj *pObj, UOI_Priv *pPriv);
  //! Get the number of granted privileges
  int GetPrivCount( );
    //! Get the object on which the privilege corresponding to the index
value is granted
    UOI_Obj *GetObj(int nIndex);
    //! Get the privilege granted by the privilege corresponding to the
    index value
    UOI_Priv *GetPriv(int nIndex);
  //! Get the privilege on an object
  UOI_Priv *GetPriv(UOI_Obj *pObj);
  //! Constructor function
    UOI_RolePriv ( );
    //! Destructor function
    virtual ~UOI_RolePriv ( );
  };
  class UOI_Priv : public UOI_Obj
  {
  public:
  enum PrivType { // definition of privilege types
    PRIV_READ, // read privilege
    PRIV_WRITE, // write privilege
    PRIV_RELICENSE, // re-license privilege
    PRIV_BEREAVE, // bereave privilege
    PRIV_PRINT, // print privilege
    Definitions of other privileges
  }
    //! whether there is corresponding privilege
    bool GetPriv(PrivType privType);
    //! Grant corresponding privilege
    void SetPriv(PrivType privType, bool bPriv);
  //! Constructor function
    UOI_Priv ( );
    //! Destructor function
    virtual ~UOI_Priv ( );
  };
  class UOI_SignList : public UOI_Obj
  {
  public:
    //! Constructor function
    UOI_SignList( );
    //! Destructor function
    virtual ~UOI_SignList( );
    //! Attach a new node signature and return the index value thereof
    int AddSign(UOI_Sign *pSign);
    //! Get a node signature according to a specified index value
    UOI_Sign GetSign(int index);
    //! Delete a node signature according to a specified index value
    void DelSign(int index);
    //! Get the number of the node signatures in the list
    int GetSignCount( );
  };
  class UOI_Sign : public UOI_Obj
  {
  public:
    //! Constructor function
    UOI_Sign( );
    //! Destructor function
    virtual ~UOI_Sign( );
    //! Perform the signature
    /*!
    \param pDepList the dependency list of the signature
    \param pRole the role that signs
    \param pObj the object to which the signature is attached
    */
    void Sign(UOI_SignDepList pDepList, UOI_Role pRole ,
    UOI_Obj pObj);
    //! Verify the signature
    bool Verify( );
    //! Get the dependency list of the signature
    UOI_SignDepList GetDepList( );
  };
  class UOI_SignDepList : public UOI_Obj
  {
  public:
    //! Constructor function
    UOI_SignDepList( );
    //! Destructor function
    virtual ~UOI_SignDepList( );
    //! Insert a dependency item
    void InsertSignDep(UOI_Sign *pSign);
    //! Get the number of the dependency item
    int GetDepSignCount( );
    //! Get a dependency item according to a specified item
    UOI_Sign * GetDepSign(int nIndex);
  };
```

The steps described above can be enhanced or simplified in practical applications to improve work efficiency, e.g., the private keys of the roles may be cached in the session data (which will be deleted when the session is terminated), therefore the private keys need not to be sent to the application for decryption every time, or some security measures may be omitted, or some functions may be removed. To sum up, all simplifications of the method are equivalent modifications of the method of the present invention.

An embodiment of the present invention provides a machine readable medium having instructions stored thereon that when executed cause a system to: perform a security control operation on abstract unstructured information by issuing an instruction to a platform software; wherein, said abstract unstructured information are independent of the way in which corresponding storage data are stored.

An embodiment of the present invention provides a computer-implemented system, comprising: means for performing a security control operation on abstract unstructured information by issuing an instruction; means for accepting the instruction from the application and performs the security control operation on storage data corresponding to the abstract unstructured information; wherein, said abstract unstructured information are independent of a way in which said storage data are stored.

The merits of the present invention include that: the document data security management system, equipped with identity authentication mechanism, can grant access control privilege on arbitrary logic data or encrypt any logic data, wherein the encryption is associated with identity authentication, i.e., with any one role or multiple roles. The system of the present invention can further provide digital signatures for arbitrary logic data to achieve document data security management with multiple security attributes, and protects document data from being damaged.

This embodiment of the present invention provides the system for security management by providing a tree structure for document management; the system for security management authenticates the identities of roles and allows multiple roles to log into a security session related to security authentication. The identity authentication, privilege control, signature and signature verification are provided based on the roles. According to the access control, the security control privileges on document data of any subtree can be specified and granted by a role. In the present security session, the privileges of the document data of a certain subtree are the union of the privileges of all roles. In the security session, the security control privileges on the document data can be granted and bereaved of by a role. And the access control is provided by encrypting the document data of any subtree. Signatures can be attached to any subtree data and be verified, the process of signing is included in the security session and performed with the private key of a role in the role list unit. Before attaching signatures to the document data of a tree structure, the tree can be regularized so as to guarantee that different digital signatures are attached to different nodes.

The present invention also provides a system for document data security management in which identity authentication, access control and signature verification are integrated and the identity authentication, access control and signature verification on document data are not limited to the document data. All document data in the system are under security control, i.e., are subject to authentication, access control, signature and signature verification.

The document security technique provided by the present invention, including role oriented privilege management, security session channel, role authentication, login of multiple roles, regularization method for tree structure, fine-grained privilege management unit, privilege setup based on encryption, etc., can be applied to other environment as well as the document processing system provided by the present invention, and the present invention does not limit the applications of the document security technique.

In the document processing system to which the present invention is applied, an “adding without altering” scheme is adopted to enable the document processing system to imitate the features of paper well. Every application adds only new contents into the existing document contents without altering or deleting any existing document contents, therefore a page of the document is like a piece of paper on which different people may write or draw with different pens while nobody may alter or delete existing contents. To be specific, an application, while editing a document created by another application, adds a new layer into the document and puts all the contents added by the application into the new layer without altering or deleting contents in existing layers. Therefore every layer of the document can only be managed and maintained by one application and no application shall be allowed to edit layers added by other application. Since the modern society works based on paper, the document processing system will perfectly satisfy all application needs at present and is sufficiently practical as long as the document processing system provides all features of paper.

A digital signature object on a layer can be used for guaranteeing that the contents on the layer is not altered or deleted after the creation of the contents. The digital signature may be attached to the contents of the layer, yet preferably, the digital signature is attached to the contents of the layer and the contents of all layers created before the layer. The signature does not prevent further editing of the document such as inserting notes into the documents, and the signature shall always remain valid as long as the newly added contents are placed in a new layer without modifying the layers to which the signature is attached; however the signer of the signature is responsible only for the contents to which the signature is attached and is not responsible for any contents added after the signature is attached. This technical scheme perfectly satisfies practical needs and is highly valuable in practical applications since the signature techniques in the prior art either forbid editing or destroy the signature after editing (even though the editing process including only adding without altering).

The technical scheme provided in the fore-going description does not allow alteration of existing contents in the document, even when the technical scheme does not include paper features or digital signature, all modifications shall still be made based on a layout object, i.e., editing (adding, deleting, modifying) of a layout object does not affect any other layout objects. When a user needs to edit existing contents in the document in conventional way, another technical scheme will satisfy the need well. The technical scheme allows the application to embed a source file (a file which is saved in the format provided by the application and which keeps a full relation record of all objects in the document, e.g., a .doc file) into the document after the application has finished the initial editing and created a new layer for the newly edited contents. Next time when the document needs to be edited, the source file will be extracted from the document and the modifications shall be made in the source file. After the second editing process, the layer managed by the application shall be deleted and the modified contents of the deleted layer are created, and the modified source file shall be embedded into the document.

To be specific, the technical scheme includes steps as follows.

1. When the application processes the document for the first time, the application creates a new layer and inserts the layout object(s) corresponding to the newly added contents into the new layer, at the same time the application saves the newly added contents in the format defined by the application (i.e., the source file).

2. Create a source file child object under the document object to embed the source file (e.g., embed as a whole in binary data format), and record the layer corresponding to the source file object.

3. When the same application edits the document for the second time, the application extracts corresponding source file from corresponding source file object.

4. The application continues to edit the contents on corresponding layer by modifying the source file. Since the source file is saved in the format defined by the application, the application may edit the contents with functions of the application.

5. After the second editing process ends, the contents of the layer shall be updated according to the newly edited contents (e.g., by the mode of creating all after removing all), and the modified source file shall be embedded into the document again.

6. Such process will be repeated to enable the application to edit the existing contents in the document in a conventional way.

The technical scheme of the present invention can maximize the document interoperability. When the technical scheme of the present invention is applied to both applications and documents, and sufficient security privileges are granted, the following functions can be achieved:

1. All types of applications can correctly open, display and print all types of documents;

2. All types of applications can add new contents to all types of documents without damaging existing signatures in the documents;

3. All types of applications can edit existing contents of the all types of documents based on layouts regardless of existing signatures in the documents (where no signature exists or the signatures can be destroyed);

4. Existing contents of all types of documents can be edited in the conventional way by the original application that created the existing contents in the documents.

It can be seen that the present invention greatly facilitates the management, interoperability and security setting for the document by the layer management.

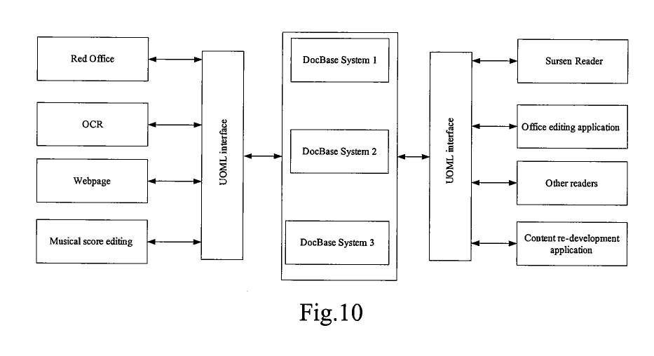

An embodiment of the present invention is given hereinafter with reference to FIG. 10 to illustrate an operation performed by the document processing system in compliance with the present invention. In the embodiment, the application requests to process a document through a unified interface standard (e.g., UOML interface). The docbase management systems may be developed by different manufacturers and may have different models, but the application developers always face a same interface standard so that the docbase management systems of any model from any manufacturer can cooperation with the application. The applications e.g., Red Office, OCR, webpage generation software, musical score editing software, Sursen Reader, Microsoft Office, or any other reader applications, instruct a docbase management system via the UOML interface to perform an operation. Multiple docbase management systems may be employed, as shown in the FIG. 10 as Docbase 1, Docbase 2 and Docbase 3. The docbase management systems process documents in compliance with the universal document model, e.g., create, save, display and present documents, according to unified standard instructions from the UOML interface. In the present invention, different applications may invoke a same docbase management system at the same time or at different time, and a same application may invoke different docbase management systems at the same time or at different time.

The present invention provides better security mechanism, multiple role setup and fine-grained role privilege setup. The fine-grained role privilege setup includes two aspects: on one hand, a privilege may be granted on a whole document or any tiny part of the document, on the other hand, varieties of privileges may be set up besides the conventional three privilege levels of write/read/inaccessible.

The present invention improves system performance and provides better transplantability and scalability. Any platform with any function may use a same interface, therefore the system performance can be optimized continuously without altering the interface standard, and the system may be transplanted to different platforms.

The foregoing description is only preferred embodiments of the present invention and is not for use in limiting the protection scope thereof. All the modifications, equivalent replacements or improvements in the scope of the present invention's sprit and principles shall be included in the protection scope of the present invention.

1. A method for document security control, comprising:
by an application, performing a security control operation on abstract unstructured information by issuing an instruction to a platform software;
by the platform software, accepting the instruction from the application software and performing the security control operation on storage data corresponding to the abstract unstructured information;
wherein, said abstract unstructured information are independent of a way in which said storage data are stored.

2. The method of claim 1, wherein, the abstract unstructured information conform with a predefined document model, the security control operation conforms with a predefined security model, wherein the predefined security model defines a role and access privileges of the role.

3. The method of claim 2, wherein, the access privileges comprises any one or any combination of: read, write, re-license, and print.

4. The method of claim 2, wherein, the access privileges is set on an object of the predefined document model which is tree-structured and comprises at least document object, page object and object(s) used to describe layout.

5. The method of claim 4, wherein, the object(s) used to describe layout can be any one or any combination of object(s) for text, object(s) for graphics and object(s) for image.

6. The method of claim 4, wherein, the objects used to describe layout can be any combination of: object for status, object for text, object for line, object for curve, object for arc, object for path, object for gradient color, object for image, object for streaming media, object for metadata, object for note, object for semantic information, object for source file, object for script, object for plug-in, object for binary data stream, object for bookmark, and object for hyperlink.

7. The method of claim 4, wherein, the predefined document module further comprises a docbase object and the docbase object comprises at least one of the document object(s), or
the predefined document module further comprises a docbase object and docset object, wherein the docbase object comprises at least one of the docset object(s), and a docset object comprises at least one of document object(s) and/or at least one of docset object(s).

8. The method of claim 4, wherein, the predefined document module further comprises a layer object and the page object comprises at least one of
layer object comprising at least one of
object used to describe layout.

9. The method of claim 8, wherein, the predefined document module further comprises object stream object and the layer object comprising at least one of
object stream object comprising at least one of
object used to describe layout.

10. The method of claim 2, wherein, the application and the platform software owns a private key and a public key of a PKI key pair, respectively, under the security model.

11. The method of claim 10, wherein, the platform software creates the private key in response to an instruction to create the role for the application; provides the private key to the application; and enables the application to login to the platform software as the role via the private key.

12. The method of claim 11, wherein, the platform software verifies that the application owns the private key corresponding to the role of the application.

13. The method of claim 2, wherein: the application logs in to the platform software under multiple roles.

14. A machine readable medium having instructions stored thereon that when executed cause a system to:
accept an instruction from an application which perform a security control operation on abstract unstructured information by issuing the instruction;
perform the security control operation on storage data corresponding to the abstract unstructured information; wherein, said abstract unstructured information are independent of the way in which the storage data are stored.

15. A system for document security control, comprising:
an application, embedded in a machine readable medium, which performs a security control operation on abstract unstructured information by issuing an instruction to a platform software;
the platform software, embedded in a machine readable medium, which accepts the instruction from the application and performs the security control operation on storage data corresponding to the abstract unstructured information;
wherein, said abstract unstructured information are independent of a way in which said storage data are stored.

16. The system of claim 15, wherein, the abstract unstructured information conform with a predefined document model, the security control operation conforms with a predefined security model, wherein the predefined security model defines a role and access privileges of the role.

17. The system of claim 16, wherein, the access privileges comprises any one or any combination of: read, write, re-license, and print.

18. The system of claim 16, wherein, the access privileges is set on an object of the predefined document model which is tree-structured and comprises at least document object, page object and object(s) used to describe layout.

19. The system of claim 18, wherein, the object(s) used to describe layout can be any one or any combination of object(s) for text, object(s) for graphics and object(s) for image.

20. The method of claim 16, wherein, the application and the platform software owns a private key and a public key of a PKI key pair, respectively, under the security model.
